(19) United States
(12) Patent Application Publication
(10) Pub. No.: US 2025/0211468 A1
(43) Pub. Date: Jun. 26, 2025

(54) TECHNIQUES FOR REFERENCE SIGNAL BUNDLING IN GREEN COMMUNICATION NETWORKS

(71) Applicant: QUALCOMM INCORPORATED, San Diego, CA (US)

(72) Inventors: Ahmed Attia Abotabl, San Diego, CA (US); Ahmed Elshafie, San Diego, CA (US); Hung Dinh Ly, San Diego, CA (US); Alexandros Manolakos, Athens (GR); Muhammad Sayed Khairy Abdelghaffar, San Jose, CA (US)

(21) Appl. No.: 18/850,509

(22) PCT Filed: Apr. 21, 2023
(86) PCT No.: PCT/US2023/019366

§ 371 Date: Sep. 24, 2024

(30) Foreign Application Priority Data
May 16, 2022 (GR) 20220100400

(51) Int. Cl. H04L 25/02; H04L 5/00; H04W 52/02

(52) U.S. Cl. CPC H04L 25/0228; H04L 5/0048; H04W 52/0206

(57) ABSTRACT

Techniques and devices for wireless communications are described. A user equipment (UE) may receive a message from a network entity. The message may indicate that the network entity transitioned from a first power mode to a second power mode. The first power mode may be associated with a phase continuity condition. The UE may determine a set of consecutive downlink messages transmitted from the network entity based on the received message. Each downlink message of the determined set of consecutive downlink messages may occur over a respective time interval and may satisfy the phase continuity condition. The UE may estimate a property of a channel for wireless communications between the UE and the network entity using the determined set of consecutive downlink messages.

### CROSS REFERENCE

The present Application is a 371 national stage filing of International PCT Application No. PCT/US2023/019366 by ABOTABL et al. entitled “TECHNIQUES FOR REFERENCE SIGNAL BUNDLING IN GREEN COMMUNICATION NETWORKS,” filed Apr. 21, 2023; and claims priority to Greece Patent Application No. 20220100400 by ABOTABL et al. entitled “TECHNIQUES FOR REFERENCE SIGNAL BUNDLING IN GREEN COMMUNICATION NETWORKS,” filed May 16, 2022, each of which is assigned to the assignee hereof, and each of which is expressly incorporated by reference in its entirety herein.

### FIELD OF DISCLOSURE

The present disclosure relates to wireless communication systems, including techniques for reference signal bundling in green communication networks.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more network entities, each supporting wireless communication for communication devices, which may be known as user equipment (UE). Some wireless communications systems may support a format for reporting channel state feedback in which a UE may perform channel estimation using reference signals transmitted by a network entity. In some cases, existing techniques for performing channel estimation may be deficient.

### SUMMARY

The described techniques relate to improved devices and apparatuses that support techniques for reference signal bundling in green communication networks. For example, the described techniques provide one or more enhancements for channel estimation in a wireless communications system. For example, a user equipment (UE) may receive a message from a network entity. The message may indicate that the network entity transitioned from a first power mode to a second power mode. The first power mode may be associated with a phase continuity condition. The UE may determine a set of consecutive downlink messages transmitted from the network entity based on the received message. Each downlink message of the determined set of consecutive downlink messages may occur over a respective time interval and may satisfy the phase continuity condition. The UE may estimate a property of a channel for wireless communications between the UE and the network entity using the determined set of consecutive downlink messages. The present disclosure may therefore promote improved communication reliability and improved coordination between devices, among other possible benefits.

A method for wireless communication at a UE is described. The method may include receiving, from a network entity, a message indicating that the network entity transitioned from a first power mode to a second power mode, where the first power mode is associated with a phase continuity condition, determining, based on the received message, a set of consecutive downlink messages transmitted from the network entity, where each downlink message of the determined set of consecutive downlink messages occurs over a respective time interval and satisfies the phase continuity condition, and estimating a property of a channel for wireless communications between the UE and the network entity using the determined set of consecutive downlink messages.

An apparatus for wireless communication at a UE is described. The apparatus may include a processor, memory coupled with the processor, and instructions stored in the memory. The instructions may be executable by the processor to cause the apparatus to receive, from a network entity, a message indicating that the network entity transitioned from a first power mode to a second power mode, where the first power mode is associated with a phase continuity condition, determine, based on the received message, a set of consecutive downlink messages transmitted from the network entity, where each downlink message of the determined set of consecutive downlink messages occurs over a respective time interval and satisfies the phase continuity condition, and estimate a property of a channel for wireless communications between the UE and the network entity using the determined set of consecutive downlink messages.

Another apparatus for wireless communication at a UE is described. The apparatus may include means for receiving, from a network entity, a message indicating that the network entity transitioned from a first power mode to a second power mode, where the first power mode is associated with a phase continuity condition, means for determining, based on the received message, a set of consecutive downlink messages transmitted from the network entity, where each downlink message of the determined set of consecutive downlink messages occurs over a respective time interval and satisfies the phase continuity condition, and means for estimating a property of a channel for wireless communications between the UE and the network entity using the determined set of consecutive downlink messages.

A non-transitory computer-readable medium storing code for wireless communication at a UE is described. The code may include instructions executable by a processor to receive, from a network entity, a message indicating that the network entity transitioned from a first power mode to a second power mode, where the first power mode is associated with a phase continuity condition, determine, based on the received message, a set of consecutive downlink messages transmitted from the network entity, where each downlink message of the determined set of consecutive downlink messages occurs over a respective time interval and satisfies the phase continuity condition, and estimate a property of a channel for wireless communications between the UE and the network entity using the determined set of consecutive downlink messages.

In some examples of the method, apparatuses, and non-transitory computer-readable medium described herein, receiving the message indicating that the network entity transitioned from the first power mode to the second power mode may include operations, features, means, or instructions for receiving, from the network entity, a control message indicating that downlink messages transmitted from the network entity subsequent to the control message fail to satisfy the phase continuity condition, where the determined set of consecutive downlink messages excludes the downlink messages transmitted from the network entity subsequent to the control message.

Some examples of the method, apparatuses, and non-transitory computer-readable medium described herein may further include operations, features, means, or instructions for determining, based on the received control message, a second set of consecutive downlink messages transmitted from the network entity, where the determined second set of consecutive downlink messages includes the downlink messages transmitted from the network entity subsequent to the control message, and where each downlink message of the determined second set of consecutive downlink messages occurs over a respective time interval and satisfies a second phase continuity condition and estimating the property of the channel for the wireless communications between the UE and the network entity using the determined second set of consecutive downlink messages.

In some examples of the method, apparatuses, and non-transitory computer-readable medium described herein, receiving the message indicating that the network entity transitioned from the first power mode to the second power mode may include operations, features, means, or instructions for receiving, from the network entity, a control message indicating consecutive time intervals over which downlink messages may be transmitted by the network entity while the network entity may be operating in the first power mode, and where the determined set of consecutive downlink messages includes the downlink messages transmitted from the network entity over the indicated consecutive time intervals.

In some examples of the method, apparatuses, and non-transitory computer-readable medium described herein, receiving the message indicating that the network entity transitioned from the first power mode to the second power mode may include operations, features, means, or instructions for receiving, from the network entity, a control message indicating a time interval over which a downlink message may be transmitted from the network entity while the network entity may be operating in the second power mode, and where the determined set of consecutive downlink messages excludes the downlink message transmitted from the network entity over the indicated time interval.

In some examples of the method, apparatuses, and non-transitory computer-readable medium described herein, receiving the message indicating that the network entity transitioned from the first power mode to the second power mode may include operations, features, means, or instructions for receiving, from the network entity, a control message indicating a change in a transmission parameter of the network entity and determining, based on the indicated change in the transmission parameter of the network entity, that the network entity transitioned from the first power mode to the second power mode.

In some examples of the method, apparatuses, and non-transitory computer-readable medium described herein, the transmission parameter of the network entity includes a frequency resource allocation used by the network entity for transmitting downlink messages, a transmit power used by the network entity for transmitting downlink messages, a spatial transmission relation used by the network entity for transmitting downlink messages, a number of antenna ports used by the network entity for transmitting downlink messages, or a precoder used by the network entity for transmitting downlink messages.

Some examples of the method, apparatuses, and non-transitory computer-readable medium described herein may further include operations, features, means, or instructions for receiving, from the network entity, a control message indicating a first set of power modes of the network entity in which downlink messages transmitted from the network entity satisfy the phase continuity condition and a second set of power modes of the network entity in which downlink messages transmitted from the network entity fail to satisfy the phase continuity condition.

In some examples of the method, apparatuses, and non-transitory computer-readable medium described herein, the first set of power modes includes the first power mode and the second set of power modes includes the second power mode.

In some examples of the method, apparatuses, and non-transitory computer-readable medium described herein, the first set of power modes includes the first power mode and the second power mode and the method, apparatuses, and non-transitory computer-readable medium may include further operations, features, means, or instructions for receiving a second control message indicating that downlink messages transmitted by the network entity subsequent to the second control message fail to satisfy the phase continuity condition, where the determined set of consecutive downlink messages excludes the downlink messages transmitted by the network entity subsequent to the second control message.

In some examples of the method, apparatuses, and non-transitory computer-readable medium described herein, the received second control message may be transmitted by the network entity via layer one (L1) signaling, layer two (L2) signaling, or layer three (L3) signaling.

In some examples of the method, apparatuses, and non-transitory computer-readable medium described herein, estimating the property of the channel may include operations, features, means, or instructions for performing one or more measurements on the set of multiple reference signals.

In some examples of the method, apparatuses, and non-transitory computer-readable medium described herein, the set of multiple reference signals includes positioning reference signals (PRSs) or demodulation reference signals (DMRSs).

In some examples of the method, apparatuses, and non-transitory computer-readable medium described herein, the message includes a downlink control information (DCI) message.

A method for wireless communication at a network entity is described. The method may include transitioning from a first power mode to a second power mode based on traffic conditions associated with the wireless communication at the network entity satisfying a threshold, where the first power mode is associated with a phase continuity condition and outputting a message indicating that the network entity transitioned from the first power mode to the second power mode.

An apparatus for wireless communication at a network entity is described. The apparatus may include a processor, memory coupled with the processor, and instructions stored in the memory. The instructions may be executable by the processor to cause the apparatus to transition from a first power mode to a second power mode based on traffic conditions associated with the wireless communication at the network entity satisfying a threshold, where the first power mode is associated with a phase continuity condition and output a message indicating that the network entity transitioned from the first power mode to the second power mode.

Another apparatus for wireless communication at a network entity is described. The apparatus may include means for transitioning from a first power mode to a second power mode based on traffic conditions associated with the wireless communication at the network entity satisfying a threshold, where the first power mode is associated with a phase continuity condition and means for outputting a message indicating that the network entity transitioned from the first power mode to the second power mode.

A non-transitory computer-readable medium storing code for wireless communication at a network entity is described. The code may include instructions executable by a processor to transition from a first power mode to a second power mode based on traffic conditions associated with the wireless communication at the network entity satisfying a threshold, where the first power mode is associated with a phase continuity condition and output a message indicating that the network entity transitioned from the first power mode to the second power mode.

In some examples of the method, apparatuses, and non-transitory computer-readable medium described herein, outputting the message indicating that the network entity transitioned from the first power mode to the second power mode may include operations, features, means, or instructions for outputting a control message indicating that downlink messages output from the network entity subsequent to the control message fail to satisfy the phase continuity condition.

In some examples of the method, apparatuses, and non-transitory computer-readable medium described herein, outputting the message indicating that the network entity transitioned from the first power mode to the second power mode may include operations, features, means, or instructions for outputting a control message indicating consecutive time intervals over which downlink messages may be output by the network entity while the network entity may be operating in the first power mode.

In some examples of the method, apparatuses, and non-transitory computer-readable medium described herein, outputting the message indicating that the network entity transitioned from the first power mode to the second power mode may include operations, features, means, or instructions for outputting a control message indicating a time interval over which a downlink message may be output from the network entity while the network entity may be operating in the second power mode.

In some examples of the method, apparatuses, and non-transitory computer-readable medium described herein, outputting the message indicating that the network entity transitioned from the first power mode to the second power mode may include operations, features, means, or instructions for outputting a control message indicating a change in an output parameter of the network entity.

In some examples of the method, apparatuses, and non-transitory computer-readable medium described herein, the output parameter of the network entity includes a frequency resource allocation used by the network entity for outputting downlink messages, a power used by the network entity for outputting downlink messages, a spatial relation used by the network entity for outputting downlink messages, a number of antenna ports used by the network entity for outputting downlink messages, or a precoder used by the network entity for outputting downlink messages.

Some examples of the method, apparatuses, and non-transitory computer-readable medium described herein may further include operations, features, means, or instructions for outputting a control message indicating a first set of power modes of the network entity in which downlink messages output from the network entity satisfy the phase continuity condition and a second set of power modes of the network entity in which downlink messages output from the network entity fail to satisfy the phase continuity condition.

In some examples of the method, apparatuses, and non-transitory computer-readable medium described herein, the first set of power modes includes the first power mode and the second set of power modes includes the second power mode.

In some examples of the method, apparatuses, and non-transitory computer-readable medium described herein, the first set of power modes includes the first power mode and the second power mode and the method, apparatuses, and non-transitory computer-readable medium may include further operations, features, means, or instructions for outputting a second control message indicating that downlink messages output by the network entity subsequent to the second control message fail to satisfy the phase continuity condition.

In some examples of the method, apparatuses, and non-transitory computer-readable medium described herein, the second control message may be output by the network entity via L1 signaling, L2 signaling, or L3 signaling.

### BRIEF DESCRIPTION OF THE DRAWINGS

FIGS. 1, 2A, and 2B each illustrate an example of a wireless communications system that supports techniques for reference signal bundling in green communication networks in accordance with various aspects of the present disclosure.

FIG. 3 illustrates an example of a transmission scheme that supports techniques for reference signal bundling in green communication networks in accordance with various aspects of the present disclosure.

FIG. 4 illustrates an example of a process flow that supports techniques for reference signal bundling in green communication networks in accordance with various aspects of the present disclosure.

FIGS. 5 and 6 show block diagrams of devices that support techniques for reference signal bundling in green communication networks in accordance with various aspects of the present disclosure.

FIG. 7 shows a block diagram of a communications manager that supports techniques for reference signal bundling in green communication networks in accordance with various aspects of the present disclosure.

FIG. 8 shows a diagram of a system including a device that supports techniques for reference signal bundling in green communication networks in accordance with various aspects of the present disclosure.

FIGS. 9 and 10 show block diagrams of devices that support techniques for reference signal bundling in green communication networks in accordance with various aspects of the present disclosure.

FIG. 11 shows a block diagram of a communications manager that supports techniques for reference signal bundling in green communication networks in accordance with various aspects of the present disclosure.

FIG. 12 shows a diagram of a system including a device that supports techniques for reference signal bundling in green communication networks in accordance with various aspects of the present disclosure.

FIGS. 13 through 17 show flowcharts illustrating methods that support techniques for reference signal bundling in green communication networks in accordance with various aspects of the present disclosure.

### DETAILED DESCRIPTION

Some wireless communications systems may support beamforming operations for directional communications. For example, wireless communication devices operating within a wireless communications system may communicate via directional transmissions (e.g., beams), in which beamforming may be applied (e.g., using one or more antenna elements) to form a beam in a direction. Beamforming involves a signal processing technique in which a transmitting communication device, or a receiving communication device, or both, select, shape, or steer an antenna beam (e.g., a directional beam) along a spatial path between the two communication devices (e.g., between a network entity and a user equipment (UE)). For example, a first communication device (e.g., the UE) may apply beamforming to form one or more beams (e.g., one or more uplink transmit beam or one or more downlink receive beam) for communications with a second communication device (e.g., the network entity). In some examples, beamforming applied by the UE may be based on channel estimation performed at the UE, for example on reference signals transmitting by the network entity.

For example, the network entity may transmit downlink messages (e.g., including one or more reference signals) to the UE according to a same set of transmission parameters. In such an example, a phase continuity across the multiple downlink messages may be maintained, such that the UE may jointly process (e.g., bundle) the downlink messages, thereby improving channel estimation (e.g., at the UE). In some examples, however, the network entity may transition between multiple (e.g., different) power modes associated with multiple (e.g., different) transmission parameters. For example, the network entity may change transmission parameters (e.g., a bandwidth, a number of active antennas) for downlink communications at the network entity, such as to conserve power while maintaining network operation. In some examples, by changing transmission parameters used for downlink communications at the network entity, a phase continuity of the downlink communications may also change. For example, a phase continuity of downlink messages transmitted by the network entity according to a set of transmission parameters may be different from a phase continuity of downlink messages transmitted by the network entity according to another set of transmission parameters. As such, the UE may not jointly process (e.g., perform channel estimation on) downlink messages transmitted by the network entity across multiple (e.g., different) sets of transmission parameters (e.g., across multiple power modes).

Various aspects of the present disclosure relate to techniques for reference signal bundling in green communication networks, and more specifically, to techniques for indicating whether a phase continuity has been maintained across multiple downlink messages transmitted by a network entity. For example, the network entity may transmit a message, to the UE, indicating that the network entity transitioned from a first power mode (e.g., associated with a set of transmission parameters, associated with a phase continuity condition) to a second power mode (e.g., associated with another set of transmission parameters). In some examples, based on the indication, the may determine a set of consecutive downlink messages that satisfies the phase continuity condition. That is, based on the indication, the UE may determine a set of consecutive downlink messages that may have been transmitted by the network entity according to a same set of transmit parameters, such that each downlink message of the set of consecutive downlink messages may satisfy a same phase continuity condition. In such an example, the UE may use the determined set of consecutive downlink messages for estimating a property of a channel for wireless communications between the UE and the network entity (e.g., for channel estimation).

In some examples, the network entity may indicate that the network entity transitioned from the first power mode to the second power mode via control signaling. For example, the network may transmit control signaling, to the UE, indicating that downlink messages transmitted subsequent to the control signaling satisfy (or fail to satisfy) a same continuity condition. In some other examples, the control signaling may indicate time intervals over which downlink messages are transmitted by the network entity in a power mode (e.g., the first power mode or the second power mode). Additionally, or alternatively, the control singling may indicate a change in a transmission parameter of the network entity.

Aspects of the subject matter described herein may be implemented to realize one or more of the following potential advantages. For example, the techniques employed by the described communication devices may provide benefits and enhancements to the operation of the communication devices, including enabling a UE to determine whether a phase community of downlink message transmitted by a network entity has been maintained. In some examples, operations performed by the described communication devices may provide improvements to the reliability of communications within a wireless communications system. In some examples, the operations performed by the described communication devices to improve communication reliability within the wireless communications system may include transmitting an indication of whether the network entity transitioned from a first power mode to a second power mode. In some other examples, operations performed by the described communication devices may also support increased throughput and higher data rates, among other possible benefits.

Aspects of the disclosure are initially described in the context of wireless communications systems. Aspects of the disclosure are also described in the context of a transmission scheme and a process flow. Aspects of the disclosure are further illustrated by and described with reference to apparatus diagrams, system diagrams, and flowcharts that relate to techniques for reference signal bundling in green communication networks.

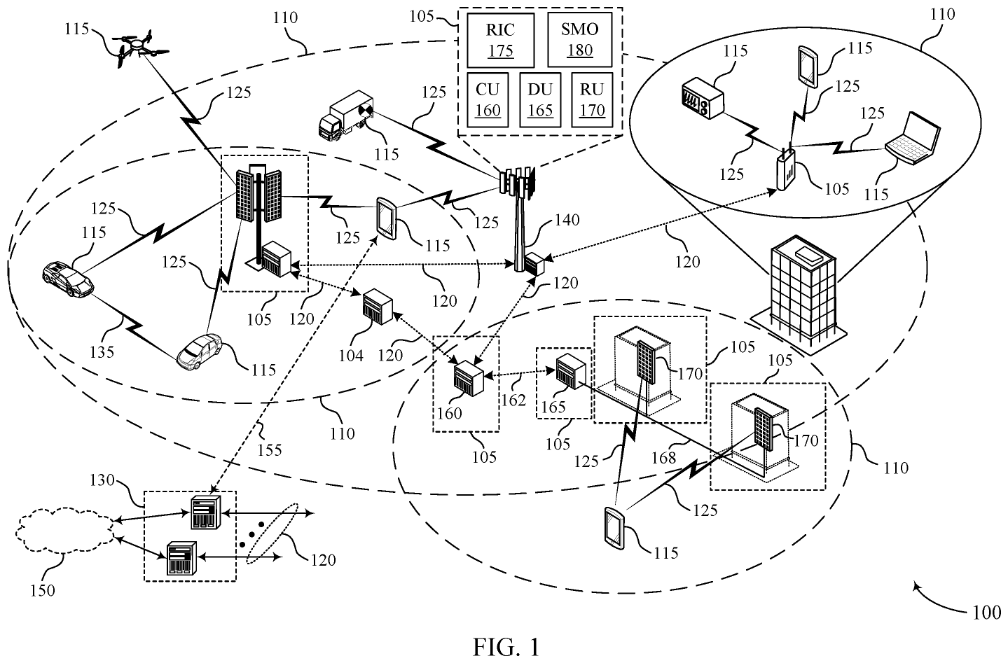

FIG. 1 illustrates an example of a wireless communications system 100 that supports techniques for reference signal bundling in green communication networks in accordance with various aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, a network entity 105, apparatus, device, computing system, or the like may include disclosure of the UE 115, the network entity 105, apparatus, device, computing system, or the like being a node. For example, disclosure that a UE 115 is configured to receive information from a network entity 105 also discloses that a first node is configured to receive information from a second node.

In some examples, the network entities 105 may communicate with the core network 130, or with one another, or both. For example, the network entities 105 may communicate with the core network 130 via one or more backhaul communication links 120 (e.g., in accordance with an S1, N2, N3, or other interface protocol). In some examples, the network entities 105 may communicate with one another over a backhaul communication link 120 (e.g., in accordance with an X2, Xn, or other interface protocol) either directly (e.g., directly between the network entities 105) or indirectly (e.g., via a core network 130). In some examples, the network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity (e.g., a donor base station). The one or more network entities 105 (e.g., IAB donors, donor network entities) may be in communication with an additional one or more network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for reference signal bundling in green communication networks as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of T_{S}=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a respective one of the multiple UE 115.

In some examples, a network entity 105 (e.g., a base station 140, an RU 170) may be movable and therefore provide communication coverage for a coverage area 110 that may be a moving coverage area. In some examples, multiple coverage areas 110 may be associated with different technologies may overlap, but the multiple coverage areas 110 may be supported by the same network entity (e.g., a network entity 105). In some other examples, coverage areas 110 that may be overlapping and associated with different technologies may be supported by a different one or more network entities 105. The wireless communications system 100 may include, for example, a heterogeneous network in which different types of the network entities 105 provide coverage for coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). For example, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), unlicensed radio frequency spectrum band radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with an orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The wireless communications system 100 may support techniques for reference signal bundling in green communication networks. For example, a UE 115 may receive a message from a network entity 105. The message may indicate that the network entity 105 transitioned from a first power mode to a second power mode. The first power mode may be associated with a phase continuity condition. The UE 115 may determine a set of consecutive downlink messages transmitted from the network entity 105 based on the received message. Each downlink message of the determined set of consecutive downlink messages may occur over a respective time interval and may satisfy the phase continuity condition. The UE 115 may estimate a property of a channel for wireless communications between the UE 115 and the network entity 105 using the determined set of consecutive downlink messages. In some examples, by indicating that the network entity 105 transitioned from the first power mode to the second power mode, the network entity 105 may provide one or more enhancements to channel estimation at the UE 115, among other possible benefits.

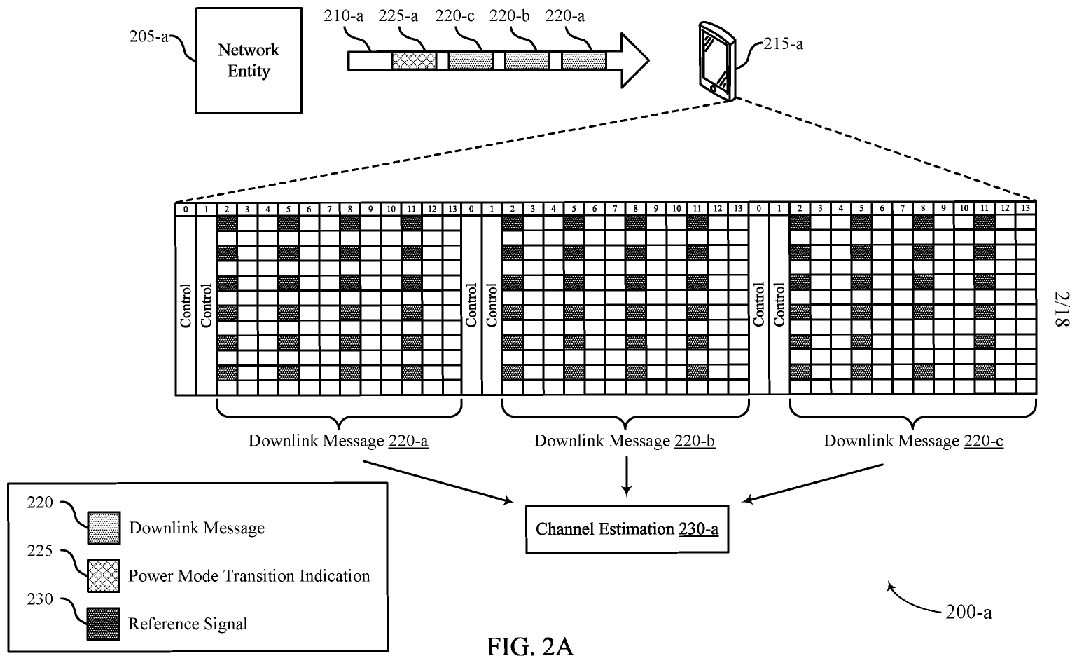

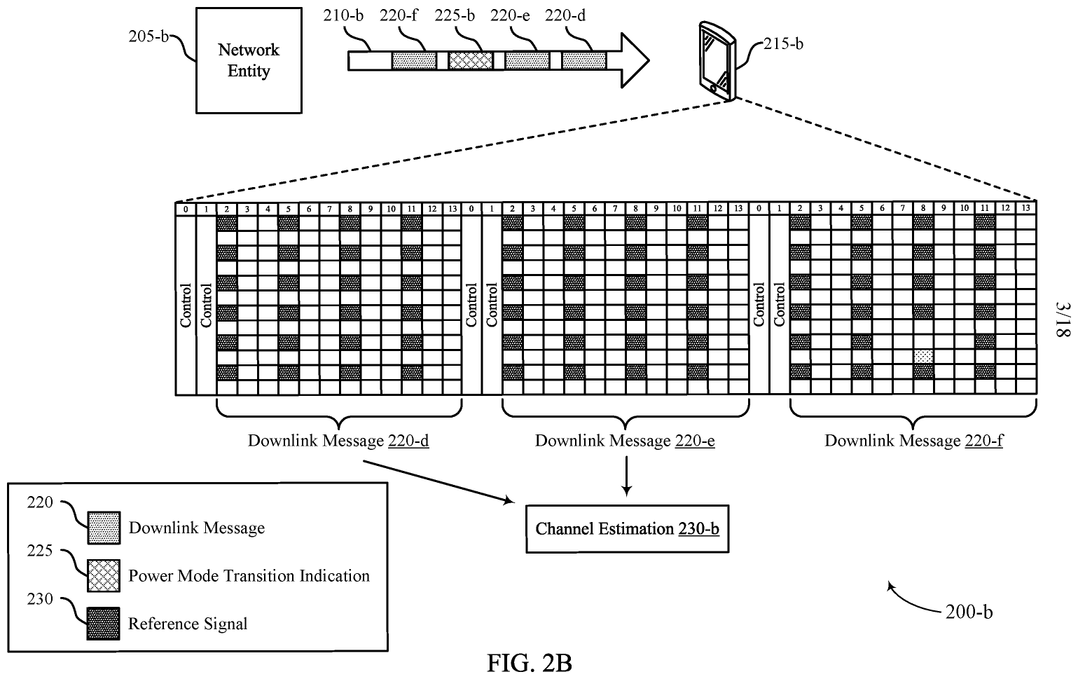

FIGS. 2A and 2B each illustrate an example of a wireless communications system 200 that supports techniques for reference signal bundling in green communication networks in accordance with various aspects of the present disclosure. The wireless communications systems 200 (e.g., a wireless communications system 200-a and a wireless communications system 200-b) may implement or be implemented by one or more aspects of the wireless communications system 100. For example, the wireless communications system 200-a and the wireless communications system 200-b may each include a network entity (e.g., a network entity 205-a and a network entity 205-b, respectively) and a UE (e.g., a UE 215-a and a UE 215-b, respectively), which may be examples of the corresponding devices as described with reference to FIG. 1. The network entities 205 and the UEs 215 may communicate via one or more communication links 210 (e.g., a communication link 210-a and a communication link 210-b), which may be examples of a communication link 125, as described with reference to FIG. 1.

In the example of FIGS. 2A and 2B, the network entities 205 may each be examples of a CU 160, a DU 165, an RU 170, or a base station 140 as described with reference to FIG. 1. Additionally, or alternatively, in the example of FIGS. 2A and 2B, the communication links 210 may be examples of a downlink. Although the examples of FIGS. 2A and 2B are illustrated in the context of downlink communications, it is to be understood that techniques for reference signal bundling in green communication networks, as described herein, may be applied for uplink communications, downlink communications, sidelink communications, or any combination thereof. For example, the operations performed by one or both of the network entities 205 may be performed by one or both of the UEs 215 (or one or more other communication devices) and the operations performed by one or both of the UEs 215 may be performed by one or both of the network entities 205 (or one or more other communication devices).

As illustrated in the example of FIG. 2A, the network entity 205-a (e.g., a transmitting device) may transmit multiple downlink messages 220 (e.g., a downlink message 220-a, a downlink message 220-b, and a downlink message 220-c) to the UE 215-a (e.g., a receiving device), while maintaining phase continuity across the multiple downlink messages. For example, the network entity 205-a may transmit each of the multiple downlink messages 220 according to (e.g., using) a same set of transmission parameters, such that a phase continuity across the multiple downlink messages 220 may be maintained. In some examples, the same set of parameters may include frequency resource allocation (e.g., one or more frequencies used for transmitting the multiple downlink messages 220), a transmit power, a spatial transmission relation (e.g., a quasi co-location relationship), a quantity of antenna ports, or a precoding matrix, among other examples. That is, conditions to maintain phase continuity (e.g., phase continuity conditions) on the multiple downlink messages 220 may include using a same frequency resource allocation (e.g., a same one or more frequencies), a same transmit power, a same spatial transmission relation (e.g., a same quasi co-location relationship), a same quantity of antenna ports, or a same precoding matrix, among other examples, across each of the downlink messages 220.

In some examples, by using the same set of transmission parameters for each of the multiple downlink messages 220, the UE 215-a (e.g., the receiving device) may jointly process the downlink messages 220, thereby improving channel estimation 230-a (or another operation for estimating one or more properties of a communication channel) at the UE 15-a. For example, the downlink messages 220 may include one or more reference signals 230 (e.g., demodulation reference signals (DMRSs), positioning reference signals (PRSs)). As such, the receiving device (the UE 215-a) may jointly process the reference signals 230 (e.g., the DMRSs, the PRSs) included in multiple downlink messages 220 (e.g., physical downlink shared channel (PDSCH) messages or physical downlink control channel (PDCCH) messages). The UE 215-a may, in some examples, refrain from jointly processing reference signals of different channel types (e.g., may refrain from jointly processing PDSCH DMRSs with PDCCHs DMRSs).

In some examples, the network entity 205-a may be capable of operating in one or more power saving modes (e.g., power modes). For example, network power saving may occur over multiple (e.g., different) modes, in which the network entity 205-a may perform operations (e.g., in a power saving mode) to save power, while maintaining network operation. The network (e.g., the network entity 205-a) may transition between power modes (e.g., switch between power modes) according to a network input, or traffic conditions (e.g., current traffic condition), or both. In some examples, transitioning between power modes may include adapting a bandwidth or number of active antennas (or both), which may impact RF transmission coherency (e.g., phase continuity). For example, in relatively low traffic conditions, the network may determine to operate in a power mode, in which the network may refrain from activating a quantity of (e.g., all) antennas at the network (e.g., at the network entity 205-a or the network entity 205-b), thereby altering (e.g., changing) a phase continuity associated with downlink transmission at the network. As a result, downlink messages transmitted by the network entity 205-a prior to the phase continuity being altered may not be jointly processed with downlink messages transmitted by the network entity 205-a subsequent to the phase continuity being altered. In such an example, channel estimation performed at the receiving device (e.g., the UE 215-a) may be degraded.

In some examples, techniques for reference signal bundling in green communication networks, as described herein, may provide one or more enhancements to channel estimation. For example, such techniques for reference signal bundling in green communication networks may enable the network entity 205 to indicate, to the UE 215-a, whether a phase continuity has been maintained for the multiple downlink messages 220 transmitted by the network entity. For example, in some green communication networks (e.g., the wireless communications system 200-a), network entities (e.g., the network entity 205-a) may be configured with multiple power saving (e.g., sleeping) modes. In such an example, the network entity 205-a may transmit a message to the UE 215-a indicating that the network entity transitioned from a first power mode (e.g., a first power saving mode) to a second power mode (e.g., a second power saving mode). For example, the network entity 205-a may transmit a power mode transition indication 225-a to the UE 215-a. In some examples, the first power mode may be associated with a phase continuity condition (e.g., a set of transmission parameters). In some examples, based on the power mode transition indication 225-a, the UE 215-a may determine a set of consecutive downlink messages (e.g., of the downlink messages 220) that satisfies the phase continuity condition (e.g., that may have been transmitted according to a same set of transmission parameters). In such an example, the UE 215-a may estimate one or more properties (e.g., perform channel estimation, perform positioning measurements) of a channel for wireless communications between the UE 215-a and the network entity 205-a using the determined set of consecutive downlink messages. For example, based on the power mode transition indication 225-a, the UE 215-a may determine that the downlink message 220-a, the downlink message 220-b, and the downlink message 220-c satisfy the phase continuity condition. As such, the UE 215-a may use the downlink message 220-a, the downlink message 220-b, and the downlink message 220-c for the channel estimation 230-a (or for performing one or more positioning measurements).

In some examples, the network entity 205-a may sequentially indicate to the UE 215-a whether a subsequent occasion (e.g., a next occasion, a next one or more multiple downlink messages, one or more subsequently transmitted downlink messages) may be jointly processed (e.g., with previously transmitted downlink message). In some examples (e.g., prior to transmitting a relatively last downlink message, prior to transmitting a relatively last DMRS bundle transmission, prior to transmitting a relatively last PRS bundle transmission), the network may transmit control signaling, such a downlink control information (DCI), to the UE 215-a to indicate whether a next occasion (e.g., a next one or more downlink messages, one or more subsequently transmitted downlink messages) may be a DMRS bundle (or a PRS bundle). Additionally, or alternatively, the network entity 205-a may multiplex an indication of whether the next occasion (e.g., a next one or more downlink messages, one or more subsequently transmitted downlink messages) may be a DMRS bundle (or a PRS bundle), for example with a PDSCH transmission.

In some other examples (e.g., subsequent to transmitting a relatively last downlink message, subsequent to transmitting a relatively last DMRS bundle transmission), the network may transmit a DCI to the UE 215-a to indicate whether active DMRS bundling may be maintained. For example, the network entity 205-a may transmit a DCI indicating a change in DMRS bundling, configured grants, dynamic grants, periodic channel state information reference signals (CSI-RS), or multiple PDSCH messages, among other examples. That is, the network entity 205-a may transmit and indication of whether phase continuity is to be maintained by the network entity 205-a for multiple downlink messages 220. For example, the network entity 205-a, may transmit a control message (e.g., the DCI) indicating that one or more downlink messages 220 transmitted from the network entity 205-a subsequent to the control message fail to maintain phase continuity (e.g., fail to satisfy a phase continuity condition).

In some examples, a change in bandwidth, a quantity of antenna ports, or a transmit power (or some combination thereof) at the network entity 205-b may lead to a change in RF transmission coherency or a change in a channel impulse response (e.g., in some states, in some power saving modes) of downlink messages transmitted by the network entity 205-b. As such, if the network entity 205-b transitions from one power mode to another, such that a change in one or more transmission parameters of the network entity 205-b (e.g., a bandwidth, a quantity of antenna ports, a transmit power) occurs, phase continuity may not be maintained (e.g., for some DMRS bundles). As illustrated in the example of FIG. 2B, the network entity 205-b may transmit a power mode transition indication 225-b to the UE 215-b that may indicate that the network entity transitioned from a first power mode to a second power mode (e.g., may indicate that subsequent downlink messages fail satisfy the phase continuity condition). In such an example, based on the power mode transition indication 225-b, the UE 215-b may determine that a set of consecutive downlink messages that satisfy the phase continuity condition (e.g., and may be used for estimating one or more properties of a channel) includes a downlink message 220-d and a downlink message 220-e and excludes a downlink message 220-f (e.g., a downlink message transmitted subsequent to the power mode transition indication 225-b). In such an example, the UE 215-b may estimating a property of a channel for wireless communications between the UE 215-b and the network entity 205-b using the determined set of consecutive downlink messages. For example, the UE 215-b may use the downlink message 220-d the downlink message 220-e for a channel estimation 230-b.

Although the example of FIG. 2B illustrates the power mode transition indication 225-b being transmitted prior to the downlink message 220-f (e.g., a downlink message in which phase continuity may not be maintained) it is to be understood that the power mode transition indication 225-b may be transmitted prior to, subsequent to, or concurrently with one or multiple of the downlink messages 220. For example, the power mode transition indication 225-b may be an example of a cancellation indication or a preemption indication. In some examples, network entity 205-b may transmit a downlink (or uplink) cancellation indication or a downlink preemption indication (e.g., via a DCI) that may cancel downlink DMRS bundling of one or more of configured grant transmissions. For example, the network entity 205-b may transmit a control message (e.g., the DCI) indicating a time interval over which downlink messages transmitted from the network entity fail to maintain phase continuity (e.g., fail to satisfy a phase continuity condition). In some examples, the downlink (or uplink) cancellation indication may include slots indices of downlink messages (or reference signals, such as DMRSs) that may be bundled. That is, the network entity 205-b may transmit a control message indicating consecutive time intervals over which downlink messages transmitted by the network entity 205-b maintain phase continuity (e.g., satisfy the phase continuity condition).

In some examples, an indication of power mode change (e.g., a power state change) or a communication state change may indicate (e.g., inherently) a power saving mode change that may include a change in one or more parameters (e.g., a change of a bandwidth, a transmit power, or a quantity of antennas) and may lead to a change phase coherency (e.g., the phase continuity condition). For example, the network entity 205-b may indicate a change of the transmit antennas (e.g., from about 62 antennas to about 32 antennas) at the network entity 205-b or a change of the network entity 205-b transmit power, that may impact channel estimation (e.g., estimation of one or more properties of a communication channel). That is, downlink messages transmitted with different quantities of transmit antenna or at different transmit powers may lead to different channel estimation results and, therefore, may not be combined. As such, an indication of a power mode change (e.g., a power state change) or an indication of a change in one or more transmission parameters may indicate for the UE 215-b to cancel (or defer) DMRS bundling (or PRS bundling).

For example, the network may transmit a control message indicating a change in a transmission parameter of the network entity 205-b. In such an example, the UE may determine that the network entity 205-b transitioned from the first power mode to the second power mode based on the indication. In some examples, the UE 215-b may be capable of partial DMRS bundling. For example, if the UE 215-b determines a change in a power mode at the network entity 205-b the UE 215-b may perform partial bundling cancellation, in which the UE 215-b may perform DMRS bundling within a power mode (e.g., and may refrain from performing DMRS bundling across multiple power modes). In some examples, by determining whether the network entity 205-b transitioned between power modes (e.g., changed from one power mode to another), the UE 215-b may provide one or more enhancements to channel estimation at the UE 215-b among other possible benefits.

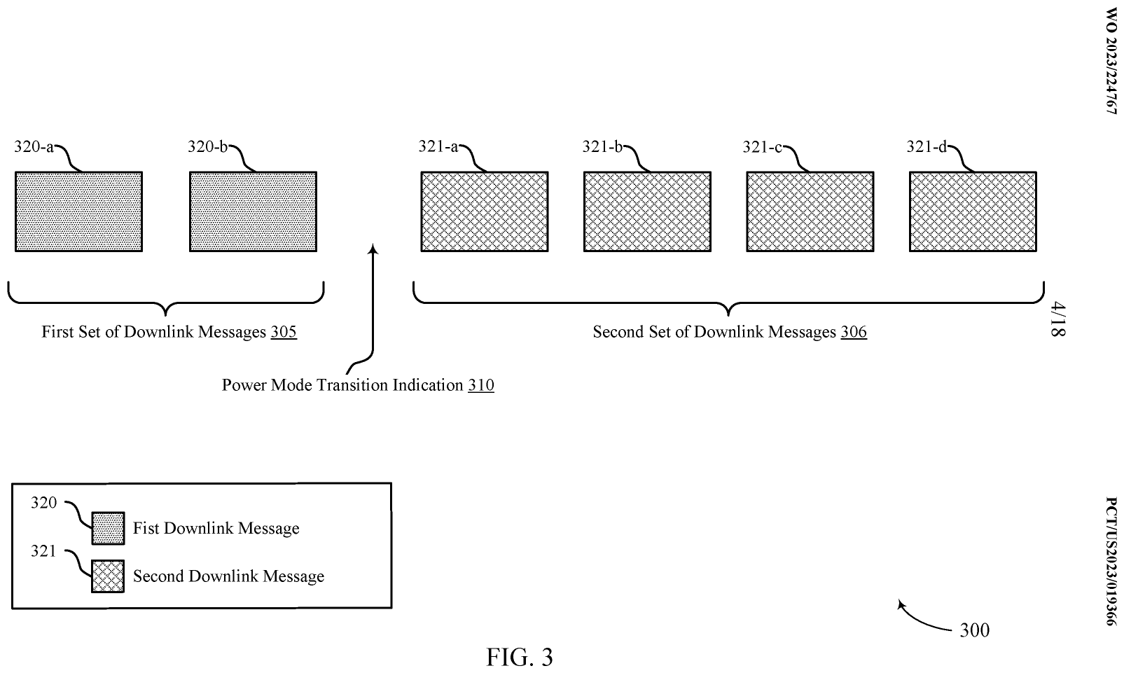

FIG. 3 illustrates an example of a transmission scheme 300 that supports techniques for reference signal bundling in green communication networks in accordance with various aspects of the present disclosure. The transmission scheme 300 may implement or be implemented by one or more aspects of the wireless communications system 100 and the wireless communications systems 200. For example, the transmission scheme 300 may be implemented by a network entity and a UE, which may be examples of the corresponding devices as described with reference to FIGS. 1, 2A, and 2B. In the example of FIG. 3, the network entity may be an example of a CU 160, a DU 165, an RU 170, or a base station 140, as described with reference to FIG. 1. Additionally, or alternatively, in the example of FIG. 3, operations performed by the network entity may be performed by the UE (or one or more other communication devices) and the operations performed by the UE may be performed by the network entity (or one or more other communication devices).

In some wireless communications systems, the network entity may change a quantity of transmit antennas (or one or more other transmission parameters) used at the network entity for power saving (e.g., for downlink communications), which may lead to changes in estimated properties of a communication channel (e.g., equivalent channel changes). For example, by changing the number of transmit antennas (or one or more other transmission parameters) used by the network entity for transmitting downlink messages, a device receiving the downlink messages (e.g., the UE) may experience (e.g., detect) changes in the communication channel over which the downlink messages are transmitted. As such, the UE may refrain from using the downlink messages to estimate one or more properties of the communication channel. That is, if the network entity transitions from one power mode to another power mode, such that a number of transmit antenna used by the network entity (or another transmission parameter) changes, at a time over which multiple downlink messages (e.g., a DMRS bundled transmission, multiple downlink CSI-RSs) are transmitted by the network entity, the UE (e.g., the receiving device) may refrain from combining (e.g., bundling, jointly processing) the downlink messages (e.g., the channels across the DMRS bundled transmissions, the channels across the multiple downlink CSI-RS).

For example, to avoid increased power consumption at the UE (e.g., to avoid wasting power at the UE), to sustain an activate state of one or more power amplifiers at the UE (e.g., to keep turning ON a power amplifier at the UE), to maintain phase continuity, to store and attempt to combine downlink channels (e.g., unrelated downlink channels), or for the network entity to stores and attempt to combine uplink channels (e.g., unrelated uplink channels), both the network entity and the UE may communicate (e.g., obtain, exchange) a position of one or more downlink messages within a set of downlink messages (e.g., a position of one or more uplink messages within a set of uplink messages, a position within a bundled transmissions) based on one or more maintained transmission parameters (e.g., time, frequency, precoding, spatial filters, quantity of antennas). In such an example (e.g., by communicating a position of one or more downlink messages within a set of downlink messages), the UE (or the network entity) may restart (e.g., resume, continue) the set of downlink messages (e.g., the bundle) subsequent to a change in a power mode at the network entity (e.g., a power saving change). For example, downlink message transmissions prior to the change in the power mode may be included in a set (e.g., a bundle) and downlink message transmissions subsequent to the change in the power mode may be included in another set (e.g., a different set, a different bundle). That is, transmissions prior to the power mode change may be included in one set of bundled transmissions and transmissions subsequent to the power mode change may be included in another bundle. Therefore, by indicating a power mode change (or communication state change associated with power mode, or a power saving power configuration mode change), the UE (or network entity) may determine which transmissions (e.g., downlink messages) to include in a bundle (e.g., which transmissions may be jointly processed).

As illustrated in the example of FIG. 3, the UE may determine to (or be configured to) use (e.g., bundle, combine, include) multiple downlink messages transmitted by the network entity (e.g., over a channel) for channel estimation (e.g., for estimation one or more properties of a communication channel). For example, the network entity may transmit multiple downlink messages (e.g., multiple of the first downlink messages 320 and the second downlink messages 321). In some examples, the network entity may transmit the multiple of the first downlink messages 320 (e.g., a first downlink message 320-a and a first downlink message 320-b) according to a set of transmission parameters (e.g., in a first power mode associated with a first phase continuity condition). The network entity may transition from the first power mode (e.g., associated with the first phase continuity condition) to a second power mode associated with a second phase continuity condition (e.g., the network entity may change one or more parameters used by the network entity for transmitting downlink messages). As such, the network entity may transmit an indication (e.g., a power mode transition indication 310), to the UE, indicating that the network entity transitioned from the first power mode to the second power mode. For example, the network entity may transmit a sleeping mode change indication or a DCI to restart bundling for one or more sets of downlink messages (e.g., one or more active bundles, one or more sets of scheduled downlink messages). In response to receiving the power mode transition indication 310, the UE may determine to include (e.g., bundle, combine) the first downlink message 320-a and the first downlink message 320-b in a first set of downlink messages 305. Each first downlink message 320 included in the first set of downlink messages 305 may be transmitted according to a same set of transmission parameters (e.g., may satisfy the first phase continuity condition). Therefore, in some examples, the UE may use the first set of downlink messages 305 (e.g., DMRSs or CSI-RSs included in the first set of downlink messages 305) for estimating one or more properties of the channel.

In some examples, the network entity may transmit (e.g., subsequent to transmitting the power mode transition indication 310) other downlink messages (e.g., a second downlink message 321-a, a second downlink message 321-b, a second downlink message 321-c, and a second downlink message 321-d) to the UE in the second power mode (e.g., according to another set of transmission parameters) associated with the second phase continuity condition. In such examples, the UE may determine to include (e.g., bundle, combine) the second downlink message 321-a, the second downlink message 321-b, the second downlink message 321-c, and the second downlink message 321-d in a second set of downlink messages 306. That is, the UE may determine to resume (e.g., restart) bundling downlink messages subsequent to receiving the power mode transition indication 310.

For example, if the UE determines a changes in the transmit power (or one or more other transmission parameters) of the first set of downlink messages 305 (e.g., a first bundle), the UE may restart a set of downlink messages (e.g., a DMRS bundle) based on a power configuration (e.g., transmission parameters) used during the second power saving mode. In some examples, each of the second downlink messages 321 included in the second set of downlink messages 306 may be transmitted according to a same set of parameters (e.g., may satisfy the second phase continuity condition). Therefore, the UE may use the second set of downlink messages 306 (e.g., DMRSs or CSI-RSs included in the first set of downlink messages 305) for estimating one or more properties of the channel. In some examples, by resuming bundling subsequent to receiving the power mode transition indication 310, the UE may reduce power consumption and increase performance of wireless communications at the UE, among other possible examples.

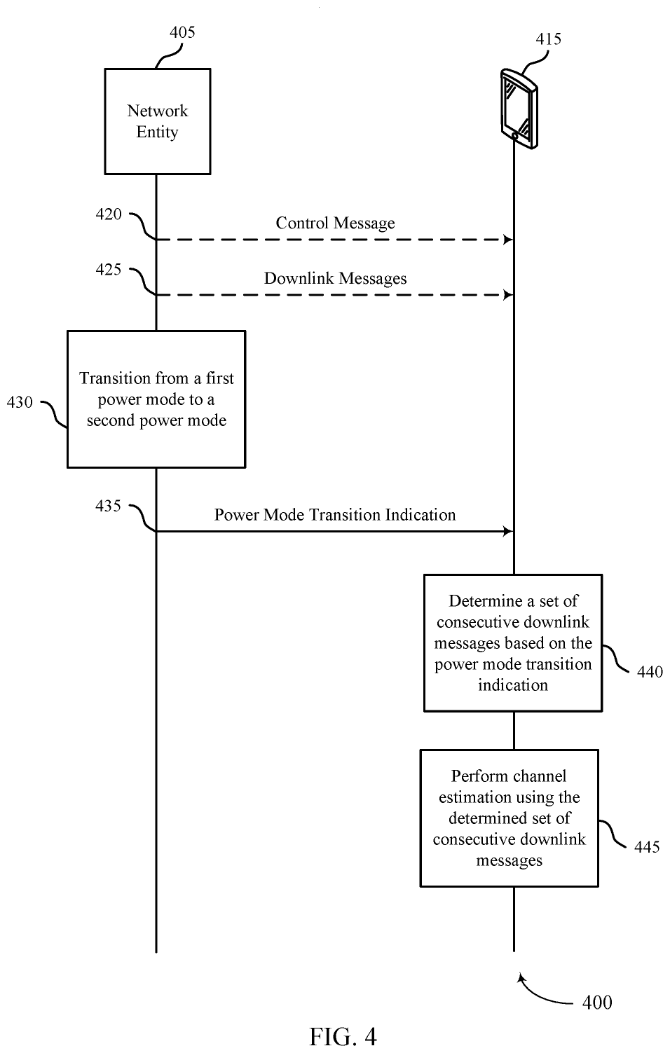

FIG. 4 illustrates an example of a process flow 400 that supports techniques for reference signal bundling in green communication networks in accordance with various aspects of the present disclosure. In some examples, the process flow 400 may include example operations associated with a UE 415 and a network entity 405, which may be examples of the corresponding devices as described with reference to FIGS. 1, 2A, and 2B. In the example of FIG. 4, the network entity may be an example of a CU 160, a DU 165, an RU 170, or a base station 140, as described with reference to FIG. 1. The operations performed by the UE 415 and the network entity 405 may support improvements to communications between one or both of the UE 415 and the network, among other benefits. In the following description of the process flow 400, operations between the UE 415 and the network entity 405 may occur in a different order or at different times than as shown. Some operations may also be omitted from the process flow 400, and other operations may be added to the process flow 400.

In some wireless communications systems, the network entity 405 may transition between multiple power saving modes (e.g., power modes), such that transmission parameters used by the network entity 405 (e.g., for transmitting downlink messages) may change and lead to a change in a phase continuity of the downlink messages. In some examples, the network entity 405 may communicate, to the UE 415, changes in power modes at the network entity 405. For example, at 420, the UE 415 may receive a control message indicating a first set of power modes of the network entity 405 in which downlink messages transmitted from the network entity 405 may satisfy a phase continuity condition (e.g., may be associated with a same set of transmission parameters). Additionally, or alternatively, the control message (e.g., transmitted at 420) may indicate and a second set of power modes of the network entity 405 in which downlink messages transmitted from the network entity 405 may fail to satisfy the phase continuity condition (e.g., may be associated with one or more other sets of transmission parameters). That is, in some examples, as part of a power saving state configuration, the network entity 405 may can indicate whether downlink bundling may be maintained (or whether downlink bundling may be disabled or enabled) within each power saving mode of multiple power saving mode supported by the network entity 405. As such, the network entity 405 may configure the UE 415 (e.g., via one or more RRC parameters, the control message) with an association (e.g., a mapping) between communication states and power modes (e.g., power saving modes) or may transmit an indication of multiple power modes that identifies whether each power mode provides for (e.g., allows for) downlink bundling. In such an example, the UE 415 may determine whether downlink messages transmitted by the network entity 405 satisfy a same phase continuity condition based on a power mode used at the network entity 405 (e.g., an indicated to the UE 415). In some examples, such as for some power modes (e.g., some communication states, some energy saving) states) in which downlink bundling may be supported by the network entity 405, the network entity 405 may transmit an indication (e.g., via layer one (L1), layer 2 (L2), or layer 3 (L3) signaling) to cancel (e.g., suspend) bundling or disabled one or more bundles. As such, if a power mode (e.g., state) supports bundling, the bundling feature may be canceled via the indication.

For example, at 425 the network entity 405 may transmit one or more downlink messages to the UE 415. In some examples, the network entity 405 may transmit the one or more downlink messages at 425 according to a first power mode associated with a set of transmission parameters (e.g., associated with a phase continuity condition). At 430, the network entity 405 may transition from the first power mode to a second power mode (e.g., based on traffic conditions associated with the wireless communication at the network entity satisfying a threshold, for relatively low traffic conditions). At 430, the network entity 405 may transmit a power mode transition indication to the UE 415.

The power mode transition indication may be an example of a power mode transition indication as described with reference to FIGS. 2A, 2B, and 3. For example, the power mode transition indication may indicate that the network entity 405 transitioned from the first power mode to the second power mode. In some examples, the power mode transition indication may indicate that downlink messages transmitted subsequent to the power mode transition indication fail to satisfy the phase continuity condition. In some other examples, the power mode transition indication may indicate time intervals over which downlink messages are transmitted by the network entity 405 while the network entity 405 may be operating in the first power mode (or in the second power mode). Additionally, or alternatively, the power mode transition indication may indicate a change in a transmission parameter of the network entity.

At 440, the UE 415 may determine a set of consecutive downlink messages transmitted from the network entity 405 based on the received power mode transition indication. The determined set of consecutive downlink messages may be an example of a set of downlink messages as described with reference to FIGS. 2A, 2B, and 3. For example, each downlink message of the determined set of consecutive downlink messages may occur over a respective time interval and may satisfy the phase continuity condition associated with the first power mode. At 445, the UE 415 may estimate a property of a channel for wireless communications between the UE 415 and the network entity 405 using the determined set of consecutive downlink messages. In some examples, by transmitting the power mode transition indication to the UE 415 (e.g., at 435), the network entity 405 may provide increased communication reliability between the UE 415 and the network entity 405, among other possible benefits.

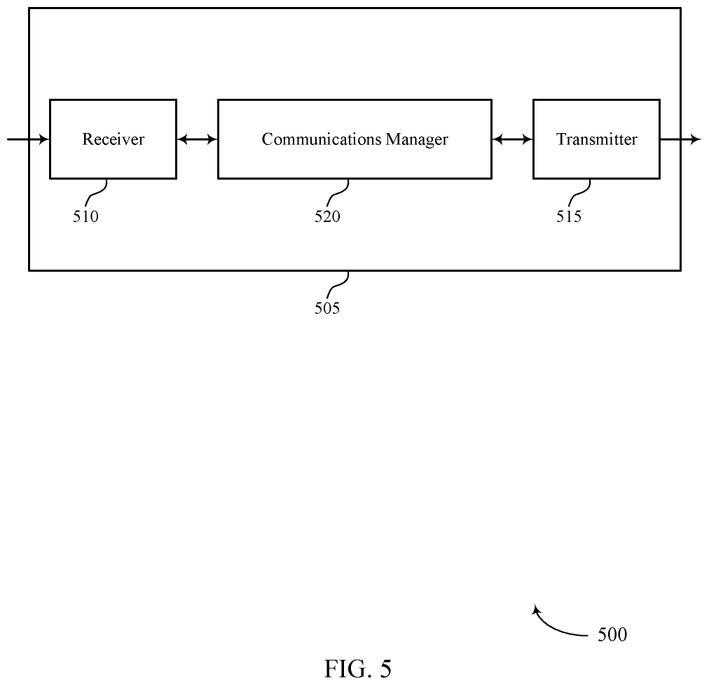

FIG. 5 shows a block diagram 500 of a device 505 that supports techniques for reference signal bundling in green communication networks in accordance with various aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for reference signal bundling in green communication networks). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for reference signal bundling in green communication networks). In some examples, the transmitter 515 may be co-located with a receiver 510 in a transceiver component. The transmitter 515 may utilize a single antenna or a set of multiple antennas.

The communications manager 520, the receiver 510, the transmitter 515, or various combinations thereof or various components thereof may be examples of means for performing various aspects of techniques for reference signal bundling in green communication networks as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE (e.g., the device 505) in accordance with examples as disclosed herein. For example, the communications manager 520 may be configured as or otherwise support a means for receiving, from a network entity, a message indicating that the network entity transitioned from a first power mode to a second power mode, where the first power mode is associated with a phase continuity condition. The communications manager 520 may be configured as or otherwise support a means for determining, based on the received message, a set of consecutive downlink messages transmitted from the network entity, where each downlink message of the determined set of consecutive downlink messages occurs over a respective time interval and satisfies the phase continuity condition. The communications manager 520 may be configured as or otherwise support a means for estimating a property of a channel for wireless communications between the UE and the network entity using the determined set of consecutive downlink messages.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced processing, reduced power consumption, and more efficient utilization of communication resources.

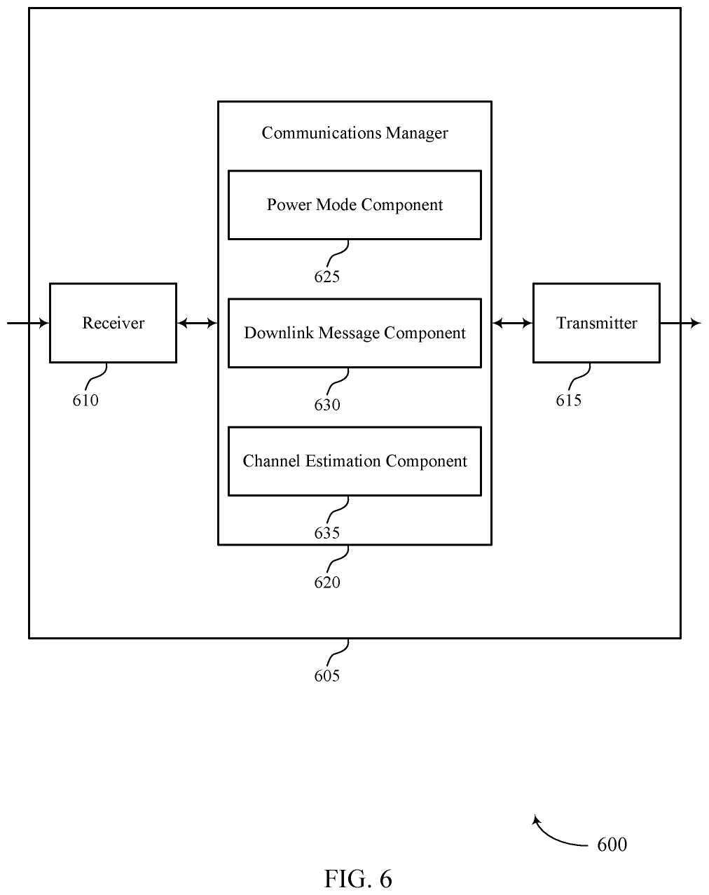

FIG. 6 shows a block diagram 600 of a device 605 that supports techniques for reference signal bundling in green communication networks in accordance with various aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for reference signal bundling in green communication networks). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for reference signal bundling in green communication networks). In some examples, the transmitter 615 may be co-located with a receiver 610 in a transceiver component. The transmitter 615 may utilize a single antenna or a set of multiple antennas.

The device 605, or various components thereof, may be an example of means for performing various aspects of techniques for reference signal bundling in green communication networks as described herein. For example, the communications manager 620 may include a power mode component 625, a downlink message component 630, a channel estimation component 635, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE (e.g., the device 605) in accordance with examples as disclosed herein. The power mode component 625 may be configured as or otherwise support a means for receiving, from a network entity, a message indicating that the network entity transitioned from a first power mode to a second power mode, where the first power mode is associated with a phase continuity condition. The downlink message component 630 may be configured as or otherwise support a means for determining, based on the received message, a set of consecutive downlink messages transmitted from the network entity, where each downlink message of the determined set of consecutive downlink messages occurs over a respective time interval and satisfies the phase continuity condition. The channel estimation component 635 may be configured as or otherwise support a means for estimating a property of a channel for wireless communications between the UE and the network entity using the determined set of consecutive downlink messages.

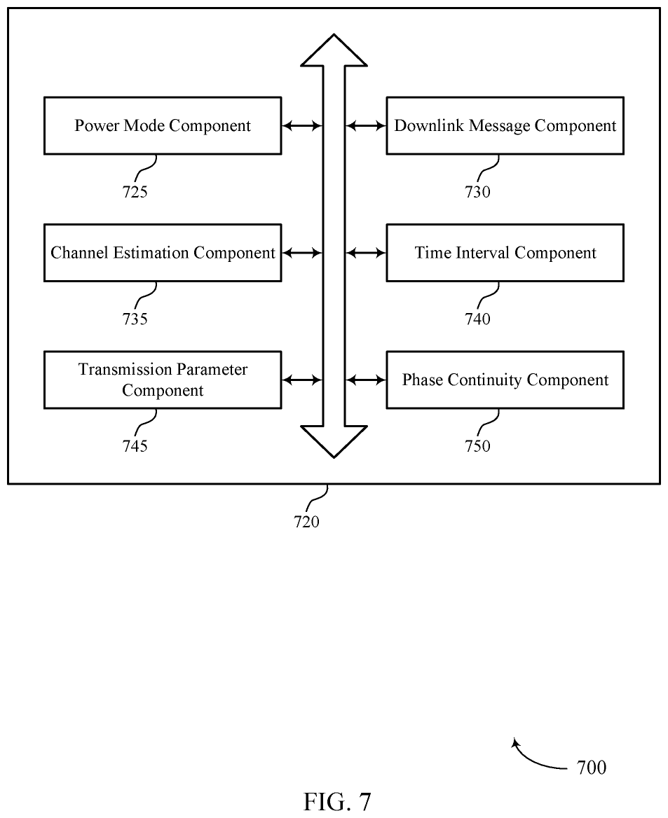

FIG. 7 shows a block diagram 700 of a communications manager 720 that supports techniques for reference signal bundling in green communication networks in accordance with various aspects of the present disclosure. The communications manager 720 may be an example of aspects of a communications manager 520, a communications manager 620, or both, as described herein. The communications manager 720, or various components thereof, may be an example of means for performing various aspects of techniques for reference signal bundling in green communication networks as described herein. For example, the communications manager 720 may include a power mode component 725, a downlink message component 730, a channel estimation component 735, a time interval component 740, a transmission parameter component 745, a phase continuity component 750, or any combination thereof. Each of these components may communicate, directly or indirectly, with one another (e.g., via one or more buses).

The communications manager 720 may support wireless communication at a UE in accordance with examples as disclosed herein. The power mode component 725 may be configured as or otherwise support a means for receiving, from a network entity, a message indicating that the network entity transitioned from a first power mode to a second power mode, where the first power mode is associated with a phase continuity condition. The downlink message component 730 may be configured as or otherwise support a means for determining, based on the received message, a set of consecutive downlink messages transmitted from the network entity, where each downlink message of the determined set of consecutive downlink messages occurs over a respective time interval and satisfies the phase continuity condition. The channel estimation component 735 may be configured as or otherwise support a means for estimating a property of a channel for wireless communications between the UE and the network entity using the determined set of consecutive downlink messages.

In some examples, to support receiving the message indicating that the network entity transitioned from the first power mode to the second power mode, the power mode component 725 may be configured as or otherwise support a means for receiving, from the network entity, a control message indicating that downlink messages transmitted from the network entity subsequent to the control message fail to satisfy the phase continuity condition, where the determined set of consecutive downlink messages excludes the downlink messages transmitted from the network entity subsequent to the control message.

In some examples, the downlink message component 730 may be configured as or otherwise support a means for determining, based on the received control message, a second set of consecutive downlink messages transmitted from the network entity, where the determined second set of consecutive downlink messages includes the downlink messages transmitted from the network entity subsequent to the control message, and where each downlink message of the determined second set of consecutive downlink messages occurs over a respective time interval and satisfies a second phase continuity condition. In some examples, the channel estimation component 735 may be configured as or otherwise support a means for estimating the property of the channel for the wireless communications between the UE and the network entity using the determined second set of consecutive downlink messages.

In some examples, to support receiving the message indicating that the network entity transitioned from the first power mode to the second power mode, the time interval component 740 may be configured as or otherwise support a means for receiving, from the network entity, a control message indicating consecutive time intervals over which downlink messages are transmitted by the network entity while the network entity is operating in the first power mode, and where the determined set of consecutive downlink messages includes the downlink messages transmitted from the network entity over the indicated consecutive time intervals.

In some examples, to support receiving the message indicating that the network entity transitioned from the first power mode to the second power mode, the time interval component 740 may be configured as or otherwise support a means for receiving, from the network entity, a control message indicating a time interval over which a downlink message is transmitted from the network entity while the network entity is operating in the second power mode, and where the determined set of consecutive downlink messages excludes the downlink message transmitted from the network entity over the indicated time interval.

In some examples, to support receiving the message indicating that the network entity transitioned from the first power mode to the second power mode, the transmission parameter component 745 may be configured as or otherwise support a means for receiving, from the network entity, a control message indicating a change in a transmission parameter of the network entity. In some examples, to support receiving the message indicating that the network entity transitioned from the first power mode to the second power mode, the transmission parameter component 745 may be configured as or otherwise support a means for determining, based on the indicated change in the transmission parameter of the network entity, that the network entity transitioned from the first power mode to the second power mode.

In some examples, the transmission parameter of the network entity includes a frequency resource allocation used by the network entity for transmitting downlink messages, a transmit power used by the network entity for transmitting downlink messages, a spatial transmission relation used by the network entity for transmitting downlink messages, a number of antenna ports used by the network entity for transmitting downlink messages, or a precoder used by the network entity for transmitting downlink messages.

In some examples, the phase continuity component 750 may be configured as or otherwise support a means for receiving, from the network entity, a control message indicating a first set of power modes of the network entity in which downlink messages transmitted from the network entity satisfy the phase continuity condition and a second set of power modes of the network entity in which downlink messages transmitted from the network entity fail to satisfy the phase continuity condition. In some examples, the first set of power modes includes the first power mode and the second set of power modes includes the second power mode.

In some examples, the first set of power modes includes the first power mode and the second power mode, and the phase continuity component 750 may be configured as or otherwise support a means for receiving a second control message indicating that downlink messages transmitted by the network entity subsequent to the second control message fail to satisfy the phase continuity condition, where the determined set of consecutive downlink messages excludes the downlink messages transmitted by the network entity subsequent to the second control message.

In some examples, the received second control message is transmitted by the network entity via L1 signaling, L2 signaling, or L3 signaling. In some examples, to support estimating the property of the channel, the channel estimation component 735 may be configured as or otherwise support a means for performing one or more measurements on the set of multiple reference signals. In some examples, the set of multiple reference signals includes PRSs or DMRSs. In some examples, the message includes a DCI message.

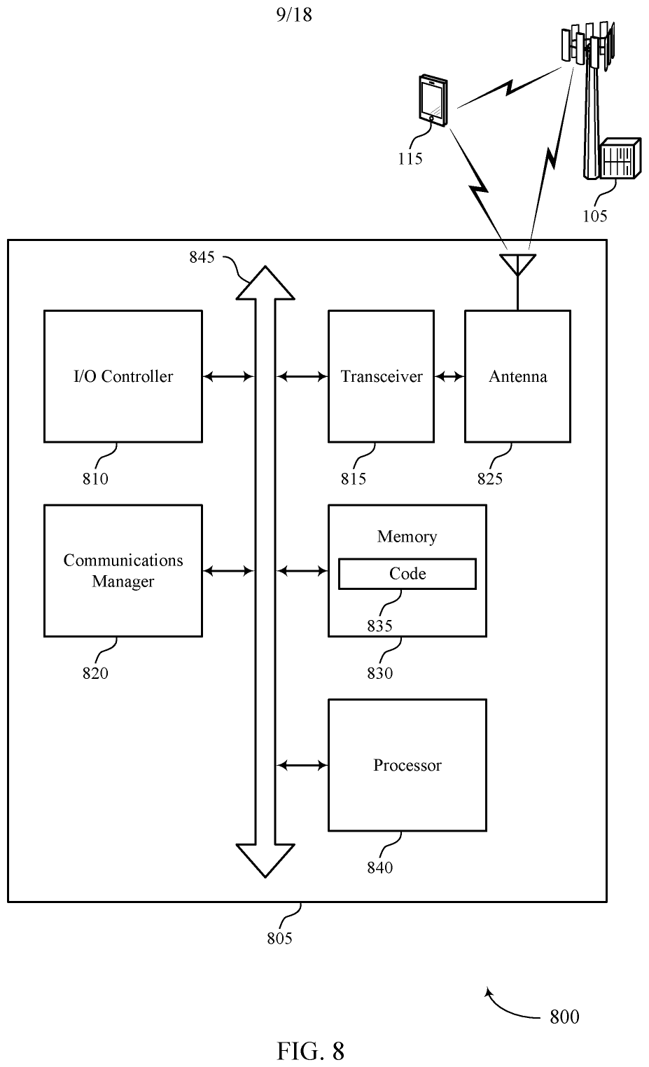

FIG. 8 shows a diagram of a system 800 including a device 805 that supports techniques for reference signal bundling in green communication networks in accordance with various aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include an antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code (e.g., the code 835) including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting techniques for reference signal bundling in green communication networks). For example, the device 805 or a component of the device 805 may include a processor 840 and memory 830 coupled with or to the processor 840, the processor 840 and memory 830 configured to perform various functions described herein.

The communications manager 820 may support wireless communication at a UE (e.g., device 805) in accordance with examples as disclosed herein. For example, the communications manager 820 may be configured as or otherwise support a means for receiving, from a network entity, a message indicating that the network entity transitioned from a first power mode to a second power mode, where the first power mode is associated with a phase continuity condition. The communications manager 820 may be configured as or otherwise support a means for determining, based on the received message, a set of consecutive downlink messages transmitted from the network entity, where each downlink message of the determined set of consecutive downlink messages occurs over a respective time interval and satisfies the phase continuity condition. The communications manager 820 may be configured as or otherwise support a means for estimating a property of a channel for wireless communications between the UE and the network entity using the determined set of consecutive downlink messages.

By including or configuring the communications manager 820 in accordance with examples as described herein, the device 805 may support techniques for improved communication reliability, reduced latency, more efficient utilization of communication resources, improved coordination between devices, and improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of techniques for reference signal bundling in green communication networks as described herein, or the processor 840 and the memory 830 may be otherwise configured to perform or support such operations.

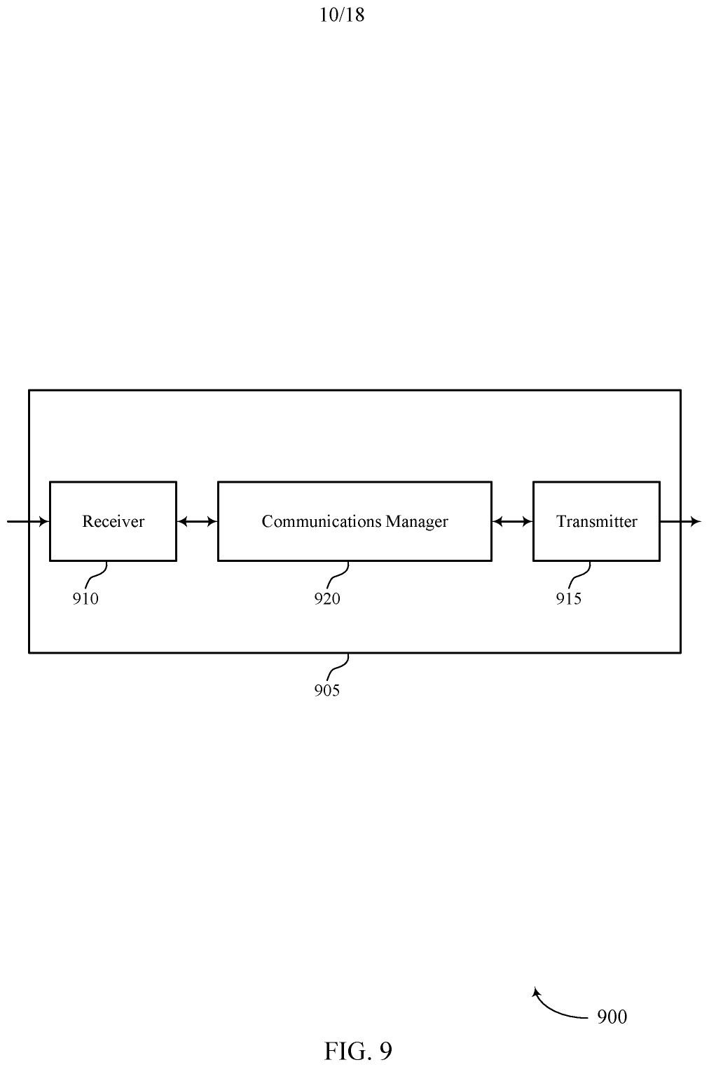

FIG. 9 shows a block diagram 900 of a device 905 that supports techniques for reference signal bundling in green communication networks in accordance with various aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of techniques for reference signal bundling in green communication networks as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a network entity (e.g., the device 905) in accordance with examples as disclosed herein. For example, the communications manager 920 may be configured as or otherwise support a means for transitioning from a first power mode to a second power mode based on traffic conditions associated with the wireless communication at the network entity satisfying a threshold, where the first power mode is associated with a phase continuity condition. The communications manager 920 may be configured as or otherwise support a means for outputting a message indicating that the network entity transitioned from the first power mode to the second power mode.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for reduced processing, reduced power consumption, and more efficient utilization of communication resources.

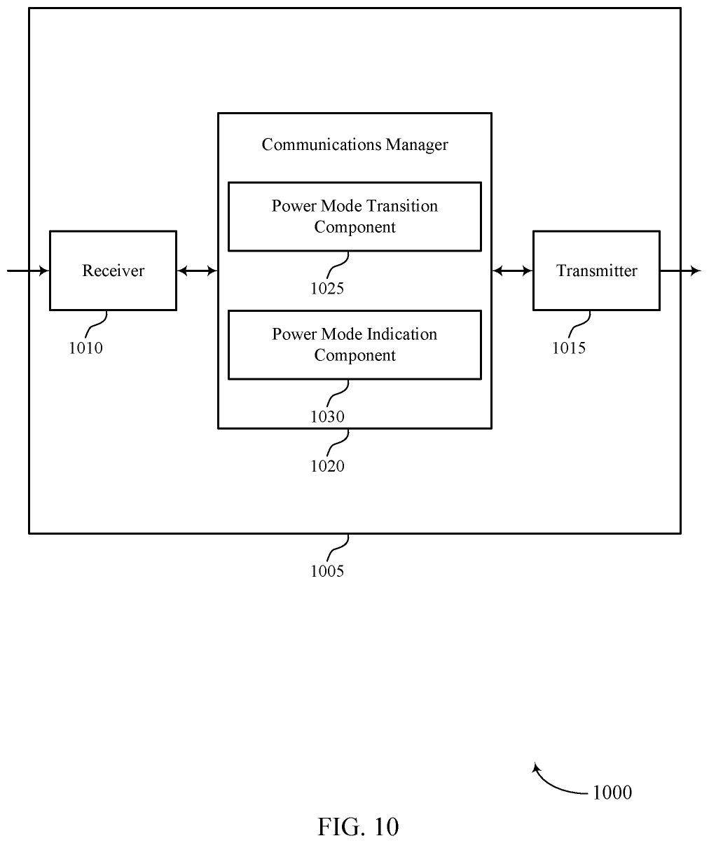

FIG. 10 shows a block diagram 1000 of a device 1005 that supports techniques for reference signal bundling in green communication networks in accordance with various aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for reference signal bundling in green communication networks as described herein. For example, the communications manager 1020 may include a power mode transition component 1025 a power mode indication component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity (e.g., the device 1005) in accordance with examples as disclosed herein. The power mode transition component 1025 may be configured as or otherwise support a means for transitioning from a first power mode to a second power mode based on traffic conditions associated with the wireless communication at the network entity satisfying a threshold, where the first power mode is associated with a phase continuity condition. The power mode indication component 1030 may be configured as or otherwise support a means for outputting a message indicating that the network entity transitioned from the first power mode to the second power mode.

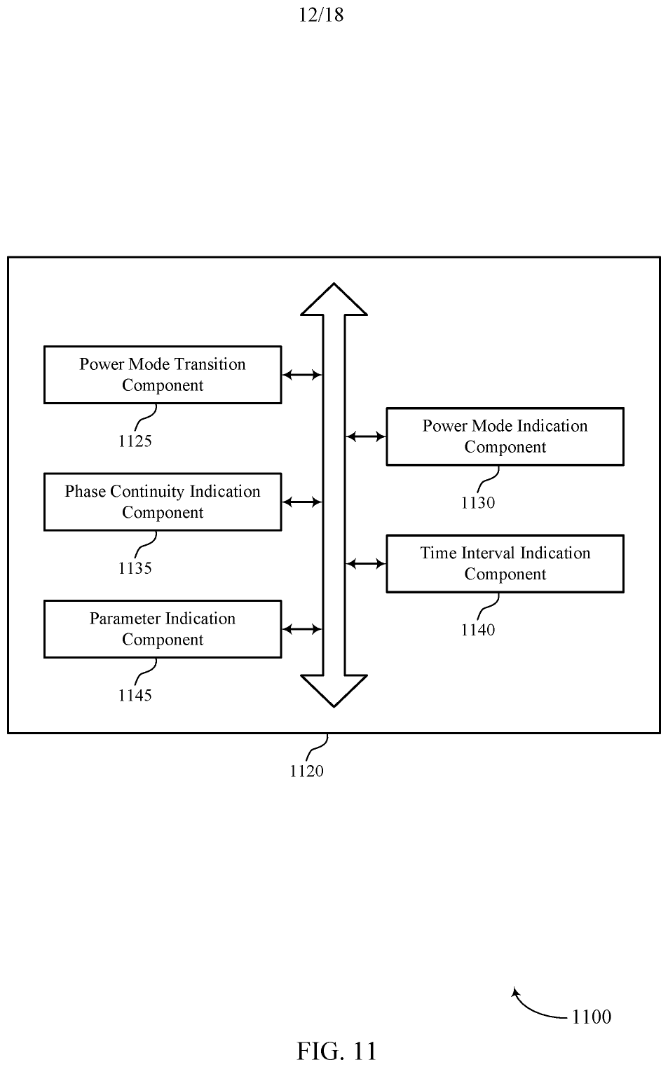

FIG. 11 shows a block diagram 1100 of a communications manager 1120 that supports techniques for reference signal bundling in green communication networks in accordance with various aspects of the present disclosure. The communications manager 1120 may be an example of aspects of a communications manager 920, a communications manager 1020, or both, as described herein. The communications manager 1120, or various components thereof, may be an example of means for performing various aspects of techniques for reference signal bundling in green communication networks as described herein. For example, the communications manager 1120 may include a power mode transition component 1125, a power mode indication component 1130, a phase continuity indication component 1135, a time interval indication component 1140, a parameter indication component 1145, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communication at a network entity in accordance with examples as disclosed herein. The power mode transition component 1125 may be configured as or otherwise support a means for transitioning from a first power mode to a second power mode based on traffic conditions associated with the wireless communication at the network entity satisfying a threshold, where the first power mode is associated with a phase continuity condition. The power mode indication component 1130 may be configured as or otherwise support a means for outputting a message indicating that the network entity transitioned from the first power mode to the second power mode.

In some examples, to support outputting the message indicating that the network entity transitioned from the first power mode to the second power mode, the phase continuity indication component 1135 may be configured as or otherwise support a means for outputting a control message indicating that downlink messages output from the network entity subsequent to the control message fail to satisfy the phase continuity condition.

In some examples, to support outputting the message indicating that the network entity transitioned from the first power mode to the second power mode, the time interval indication component 1140 may be configured as or otherwise support a means for outputting a control message indicating consecutive time intervals over which downlink messages are output by the network entity while the network entity is operating in the first power mode.

In some examples, to support outputting the message indicating that the network entity transitioned from the first power mode to the second power mode, the time interval indication component 1140 may be configured as or otherwise support a means for outputting a control message indicating a time interval over which a downlink message is output from the network entity while the network entity is operating in the second power mode.

In some examples, to support outputting the message indicating that the network entity transitioned from the first power mode to the second power mode, the parameter indication component 1145 may be configured as or otherwise support a means for outputting a control message indicating a change in an output parameter of the network entity.

In some examples, the output parameter of the network entity includes a frequency resource allocation used by the network entity for outputting downlink messages, a power used by the network entity for outputting downlink messages, a spatial relation used by the network entity for outputting downlink messages, a number of antenna ports used by the network entity for outputting downlink messages, or a precoder used by the network entity for outputting downlink messages.

In some examples, the power mode indication component 1130 may be configured as or otherwise support a means for outputting a control message indicating a first set of power modes of the network entity in which downlink messages output from the network entity satisfy the phase continuity condition and a second set of power modes of the network entity in which downlink messages output from the network entity fail to satisfy the phase continuity condition. In some examples, the first set of power modes includes the first power mode and the second set of power modes includes the second power mode.

In some examples, the first set of power modes includes the first power mode and the second power mode, and the phase continuity indication component 1135 may be configured as or otherwise support a means for outputting a second control message indicating that downlink messages output by the network entity subsequent to the second control message fail to satisfy the phase continuity condition. In some examples, the second control message is output by the network entity via layer one signaling, layer two signaling, or layer three signaling.

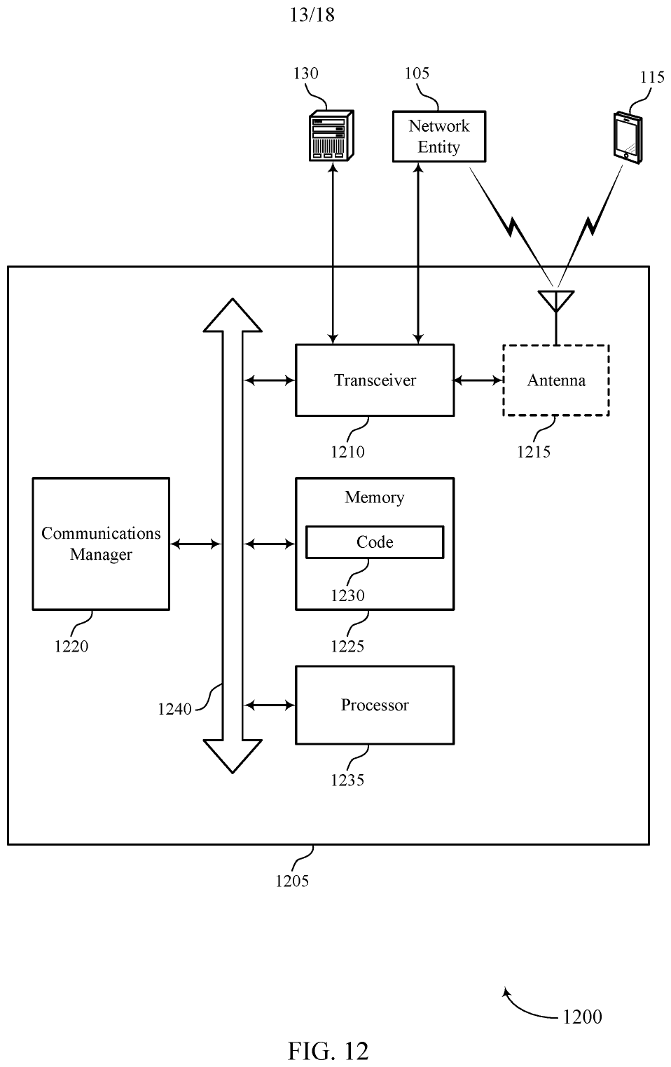

FIG. 12 shows a diagram of a system 1200 including a device 1205 that supports techniques for reference signal bundling in green communication networks in accordance with various aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. The transceiver 1210, or the transceiver 1210 and one or more antennas 1215 or wired interfaces, where applicable, may be an example of a transmitter 915, a transmitter 1015, a receiver 910, a receiver 1010, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting techniques for reference signal bundling in green communication networks). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communication at a network entity (e.g., the device 1205) in accordance with examples as disclosed herein. For example, the communications manager 1220 may be configured as or otherwise support a means for transitioning from a first power mode to a second power mode based on traffic conditions associated with the wireless communication at the network entity satisfying a threshold, where the first power mode is associated with a phase continuity condition. The communications manager 1220 may be configured as or otherwise support a means for outputting a message indicating that the network entity transitioned from the first power mode to the second power mode.

By including or configuring the communications manager 1220 in accordance with examples as described herein, the device 1205 may support techniques for improved communication reliability, reduced latency, improved user experience related to reduced processing, more efficient utilization of communication resources, improved coordination between devices, and improved utilization of processing capability.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the processor 1235, the memory 1225, the code 1230, the transceiver 1210, or any combination thereof. For example, the code 1230 may include instructions executable by the processor 1235 to cause the device 1205 to perform various aspects of techniques for reference signal bundling in green communication networks as described herein, or the processor 1235 and the memory 1225 may be otherwise configured to perform or support such operations.

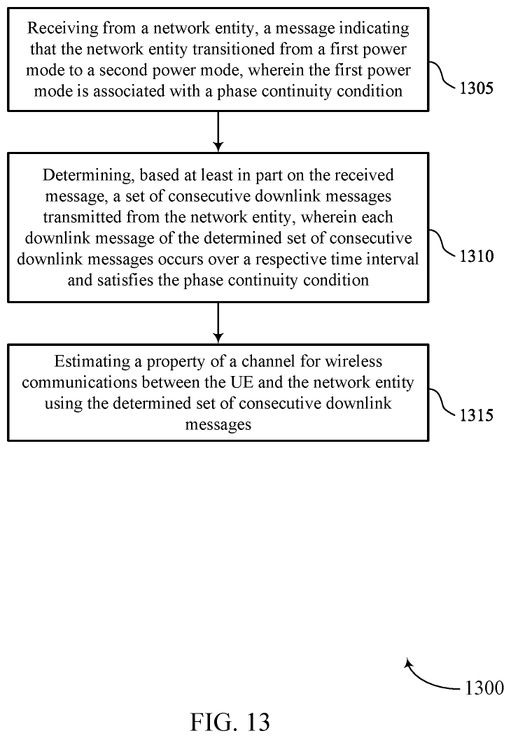

FIG. 13 shows a flowchart illustrating a method 1300 that supports techniques for reference signal bundling in green communication networks in accordance with various aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the functions of the present disclosure. Additionally, or alternatively, the UE may perform aspects of the functions of the present disclosure using special-purpose hardware.

At 1305, the method may include receiving, from a network entity, a message indicating that the network entity transitioned from a first power mode to a second power mode, where the first power mode is associated with a phase continuity condition. The operations of 1305 may be performed in accordance with examples as disclosed herein. In some examples, aspects of the operations of 1305 may be performed by a power mode component 725 as described with reference to FIG. 7.

At 1310, the method may include determining, based on the received message, a set of consecutive downlink messages transmitted from the network entity, where each downlink message of the determined set of consecutive downlink messages occurs over a respective time interval and satisfies the phase continuity condition. The operations of 1310 may be performed in accordance with examples as disclosed herein. In some examples, aspects of the operations of 1310 may be performed by a downlink message component 730 as described with reference to FIG. 7.

At 1315, the method may include estimating a property of a channel for wireless communications between the UE and the network entity using the determined set of consecutive downlink messages. The operations of 1315 may be performed in accordance with examples as disclosed herein. In some examples, aspects of the operations of 1315 may be performed by a channel estimation component 735 as described with reference to FIG. 7.

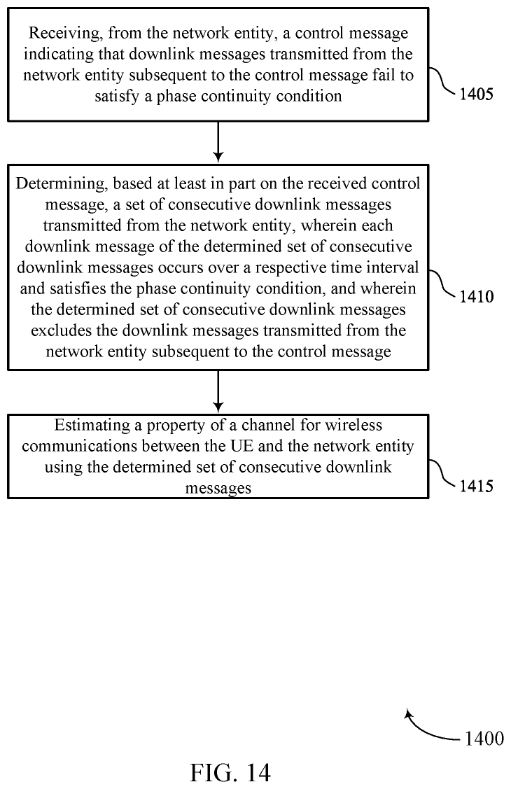

FIG. 14 shows a flowchart illustrating a method 1400 that supports techniques for reference signal bundling in green communication networks in accordance with various aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the functions of the present disclosure. Additionally, or alternatively, the UE may perform aspects of the functions of the present disclosure using special-purpose hardware.

At 1405, the method may include receiving, from the network entity, a control message indicating that downlink messages transmitted from the network entity subsequent to the control message fail to satisfy a phase continuity condition. The operations of 1405 may be performed in accordance with examples as disclosed herein. In some examples, aspects of the operations of 1405 may be performed by a power mode component 725 as described with reference to FIG. 7.

At 1410, the method may include determining, based on the received message, a set of consecutive downlink messages transmitted from the network entity, where each downlink message of the determined set of consecutive downlink messages occurs over a respective time interval and satisfies the phase continuity condition, and where the determined set of consecutive downlink messages excludes the downlink messages transmitted from the network entity subsequent to the control message. The operations of 1410 may be performed in accordance with examples as disclosed herein. In some examples, aspects of the operations of 1410 may be performed by a downlink message component 730 as described with reference to FIG. 7.

At 1420, the method may include estimating a property of a channel for wireless communications between the UE and the network entity using the determined set of consecutive downlink messages. The operations of 1420 may be performed in accordance with examples as disclosed herein. In some examples, aspects of the operations of 1420 may be performed by a channel estimation component 735 as described with reference to FIG. 7.

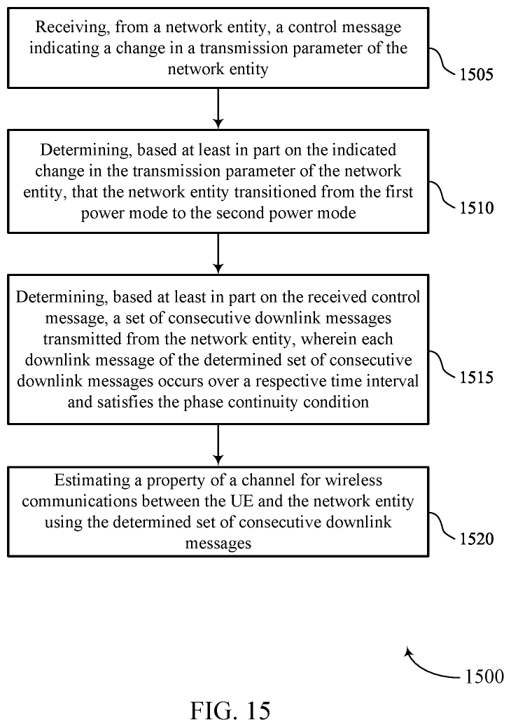

FIG. 15 shows a flowchart illustrating a method 1500 that supports techniques for reference signal bundling in green communication networks in accordance with various aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the functions of the present disclosure. Additionally, or alternatively, the UE may perform aspects of the functions of the present disclosure using special-purpose hardware.

At 1505, the method may include receiving, from a network entity, a control message indicating a change in a transmission parameter of the network entity. The operations of 1505 may be performed in accordance with examples as disclosed herein. In some examples, aspects of the operations of 1505 may be performed by a transmission parameter component 745 as described with reference to FIG. 7.

At 1510, the method may include determining, based on the indicated change in the transmission parameter of the network entity, that the network entity transitioned from the first power mode to the second power mode. The operations of 1510 may be performed in accordance with examples as disclosed herein. In some examples, aspects of the operations of 1510 may be performed by a transmission parameter component 745 as described with reference to FIG. 7.

At 1515, the method may include determining, based on the received control message, a set of consecutive downlink messages transmitted from the network entity, where each downlink message of the determined set of consecutive downlink messages occurs over a respective time interval and satisfies the phase continuity condition. The operations of 1515 may be performed in accordance with examples as disclosed herein. In some examples, aspects of the operations of 1515 may be performed by a downlink message component 730 as described with reference to FIG. 7.

At 1520, the method may include estimating a property of a channel for wireless communications between the UE and the network entity using the determined set of consecutive downlink messages. The operations of 1520 may be performed in accordance with examples as disclosed herein. In some examples, aspects of the operations of 1520 may be performed by a channel estimation component 735 as described with reference to FIG. 7.

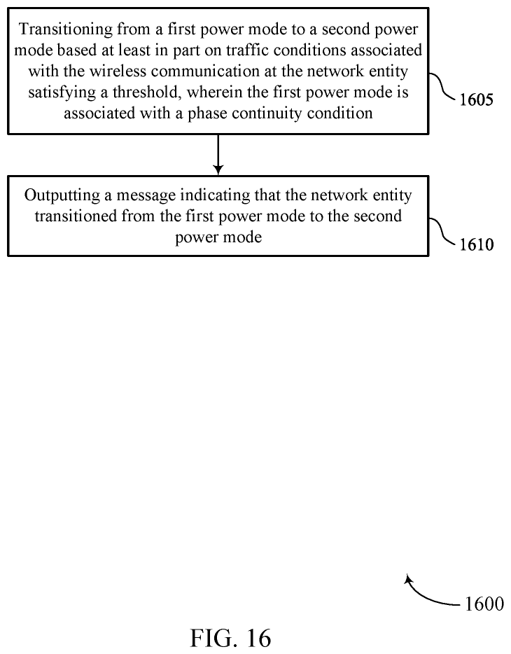

FIG. 16 shows a flowchart illustrating a method 1600 that supports techniques for reference signal bundling in green communication networks in accordance with various aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the functions of the present disclosure. Additionally, or alternatively, the network entity may perform aspects of the functions of the present disclosure using special-purpose hardware.

At 1605, the method may include transitioning from a first power mode to a second power mode based on traffic conditions associated with the wireless communication at the network entity satisfying a threshold, where the first power mode is associated with a phase continuity condition. The operations of 1605 may be performed in accordance with examples as disclosed herein. In some examples, aspects of the operations of 1605 may be performed by a power mode transition component 1125 as described with reference to FIG. 11.

At 1610, the method may include outputting a message indicating that the network entity transitioned from the first power mode to the second power mode. The operations of 1610 may be performed in accordance with examples as disclosed herein. In some examples, aspects of the operations of 1610 may be performed by a power mode indication component 1130 as described with reference to FIG. 11.

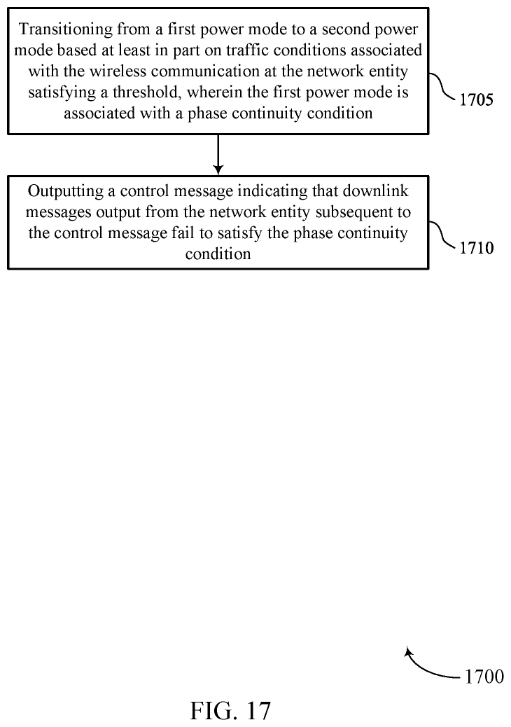

FIG. 17 shows a flowchart illustrating a method 1700 that supports techniques for reference signal bundling in green communication networks in accordance with various aspects of the present disclosure. The operations of the method 1700 may be implemented by a network entity or its components as described herein. For example, the operations of the method 1700 may be performed by a network entity as described with reference to FIGS. 1 through 4 and 9 through 12. In some examples, a network entity may execute a set of instructions to control the functional elements of the network entity to perform the functions of the present disclosure. Additionally, or alternatively, the network entity may perform aspects of the functions of the present disclosure using special-purpose hardware.

At 1705, the method may include transitioning from a first power mode to a second power mode based on traffic conditions associated with the wireless communication at the network entity satisfying a threshold, where the first power mode is associated with a phase continuity condition. The operations of 1705 may be performed in accordance with examples as disclosed herein. In some examples, aspects of the operations of 1705 may be performed by a power mode transition component 1125 as described with reference to FIG. 11.

At 1710, the method may include outputting a control message indicating that downlink messages output from the network entity subsequent to the control message fail to satisfy the phase continuity condition. The operations of 1710 may be performed in accordance with examples as disclosed herein. In some examples, aspects of the operations of 1710 may be performed by a phase continuity indication component 1135 as described with reference to FIG. 11.

The following provides an overview of aspects of the present disclosure:

Aspect 1: A method for wireless communication at a UE, comprising: receiving, from a network entity, a message indicating that the network entity transitioned from a first power mode to a second power mode, wherein the first power mode is associated with a phase continuity condition; determining, based at least in part on the received message, a set of consecutive downlink messages transmitted from the network entity, wherein each downlink message of the determined set of consecutive downlink messages occurs over a respective time interval and satisfies the phase continuity condition; and estimating a property of a channel for wireless communications between the UE and the network entity using the determined set of consecutive downlink messages.

Aspect 2: The method of aspect 1, wherein receiving the message indicating that the network entity transitioned from the first power mode to the second power mode comprises: receiving, from the network entity, a control message indicating that downlink messages transmitted from the network entity subsequent to the control message fail to satisfy the phase continuity condition, wherein the determined set of consecutive downlink messages excludes the downlink messages transmitted from the network entity subsequent to the control message.

Aspect 3: The method of aspect 2, further comprising: determining, based at least in part on the received control message, a second set of consecutive downlink messages transmitted from the network entity, wherein the determined second set of consecutive downlink messages includes the downlink messages transmitted from the network entity subsequent to the control message, and wherein each downlink message of the determined second set of consecutive downlink messages occurs over a respective time interval and satisfies a second phase continuity condition; and estimating the property of the channel for the wireless communications between the UE and the network entity using the determined second set of consecutive downlink messages.

Aspect 4: The method of aspect 1, wherein receiving the message indicating that the network entity transitioned from the first power mode to the second power mode comprises: receiving, from the network entity, a control message indicating consecutive time intervals over which downlink messages are transmitted by the network entity while the network entity is operating in the first power mode, and wherein the determined set of consecutive downlink messages includes the downlink messages transmitted from the network entity over the indicated consecutive time intervals.

Aspect 5: The method of aspect 1, wherein receiving the message indicating that the network entity transitioned from the first power mode to the second power mode comprises: receiving, from the network entity, a control message indicating a time interval over which a downlink message is transmitted from the network entity while the network entity is operating in the second power mode, and wherein the determined set of consecutive downlink messages excludes the downlink message transmitted from the network entity over the indicated time interval.

Aspect 6: The method of aspect 1, wherein receiving the message indicating that the network entity transitioned from the first power mode to the second power mode comprises: receiving, from the network entity, a control message indicating a change in a transmission parameter of the network entity; and determining, based at least in part on the indicated change in the transmission parameter of the network entity, that the network entity transitioned from the first power mode to the second power mode.

Aspect 7: The method of aspect 6, wherein the transmission parameter of the network entity comprises a frequency resource allocation used by the network entity for transmitting downlink messages, a transmit power used by the network entity for transmitting downlink messages, a spatial transmission relation used by the network entity for transmitting downlink messages, a number of antenna ports used by the network entity for transmitting downlink messages, or a precoder used by the network entity for transmitting downlink messages.

Aspect 8: The method of any of aspects 1 through 7, further comprising: receiving, from the network entity, a control message indicating a first set of power modes of the network entity in which downlink messages transmitted from the network entity satisfy the phase continuity condition and a second set of power modes of the network entity in which downlink messages transmitted from the network entity fail to satisfy the phase continuity condition.

Aspect 9: The method of aspect 8, wherein the first set of power modes includes the first power mode and the second set of power modes includes the second power mode.

Aspect 10: The method of aspect 8, wherein the first set of power modes includes the first power mode and the second power mode, the method further comprising: receiving a second control message indicating that downlink messages transmitted by the network entity subsequent to the second control message fail to satisfy the phase continuity condition, wherein the determined set of consecutive downlink messages excludes the downlink messages transmitted by the network entity subsequent to the second control message.

Aspect 11: The method of aspect 10, wherein the received second control message is transmitted by the network entity via L1 signaling, L2 signaling, or L3 signaling.

Aspect 12: The method of any of aspects 1 through 11, wherein the determined set of consecutive downlink messages comprises a plurality of reference signals, and wherein estimating the property of the channel comprises: performing one or more measurements on the plurality of reference signals.

Aspect 13: The method of aspect 12, wherein the plurality of reference signals comprises PRSs or DMRSs.

Aspect 14: The method of any of aspects 1 through 13, wherein the message comprises a DCI message.

Aspect 15: A method for wireless communication at a network entity, comprising: transitioning from a first power mode to a second power mode based at least in part on traffic conditions associated with the wireless communication at the network entity satisfying a threshold, wherein the first power mode is associated with a phase continuity condition; and outputting a message indicating that the network entity transitioned from the first power mode to the second power mode.

Aspect 16: The method of aspect 15, wherein outputting the message indicating that the network entity transitioned from the first power mode to the second power mode comprises: outputting a control message indicating that downlink messages output from the network entity subsequent to the control message fail to satisfy the phase continuity condition.

Aspect 17: The method of aspect 15, wherein outputting the message indicating that the network entity transitioned from the first power mode to the second power mode comprises: outputting a control message indicating consecutive time intervals over which downlink messages are output by the network entity while the network entity is operating in the first power mode.

Aspect 18: The method of aspect 15, wherein outputting the message indicating that the network entity transitioned from the first power mode to the second power mode comprises: outputting a control message indicating a time interval over which a downlink message is output from the network entity while the network entity is operating in the second power mode.

Aspect 19: The method of aspect 15, wherein outputting the message indicating that the network entity transitioned from the first power mode to the second power mode comprises: outputting a control message indicating a change in an output parameter of the network entity.

Aspect 20: The method of aspect 19, wherein the output parameter of the network entity comprises a frequency resource allocation used by the network entity for outputting downlink messages, a power used by the network entity for outputting downlink messages, a spatial relation used by the network entity for outputting downlink messages, a number of antenna ports used by the network entity for outputting downlink messages, or a precoder used by the network entity for outputting downlink messages.

Aspect 21: The method of any of aspects 15 through 20, further comprising: outputting a control message indicating a first set of power modes of the network entity in which downlink messages output from the network entity satisfy the phase continuity condition and a second set of power modes of the network entity in which downlink messages output from the network entity fail to satisfy the phase continuity condition.

Aspect 22: The method of aspect 21, wherein the first set of power modes includes the first power mode and the second set of power modes includes the second power mode.

Aspect 23: The method of aspect 21, wherein the first set of power modes includes the first power mode and the second power mode, the method further comprising: outputting a second control message indicating that downlink messages output by the network entity subsequent to the second control message fail to satisfy the phase continuity condition.

Aspect 24: The method of aspect 23, wherein the second control message is output by the network entity via L1 signaling, L2 signaling, or L3 signaling.

Aspect 25: An apparatus for wireless communication at a UE, comprising a processor; memory coupled with the processor; and instructions stored in the memory and executable by the processor to cause the apparatus to perform a method of any of aspects 1 through 14.

Aspect 26: An apparatus for wireless communication at a UE, comprising at least one means for performing a method of any of aspects 1 through 14.

Aspect 27: A non-transitory computer-readable medium storing code for wireless communication at a UE, the code comprising instructions executable by a processor to perform a method of any of aspects 1 through 14.

Aspect 28: An apparatus for wireless communication at a network entity, comprising a processor; memory coupled with the processor; and instructions stored in the memory and executable by the processor to cause the apparatus to perform a method of any of aspects 15 through 24.

Aspect 29: An apparatus for wireless communication at a network entity, comprising at least one means for performing a method of any of aspects 15 through 24.

Aspect 30: A non-transitory computer-readable medium storing code for wireless communication at a network entity, the code comprising instructions executable by a processor to perform a method of any of aspects 15 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such examples).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes examples and does not represent all the examples that may be implemented or that are within the scope of the claims. The term “example” used herein means “serving as an example, instance, or illustration,” and not “preferred” or “advantageous over other examples.” The detailed description includes details for the purpose of providing an understanding of the described techniques. These techniques, however, may be practiced without these details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a network entity, a message indicating that the network entity transitioned from a first power mode to a second power mode, wherein the first power mode is associated with a phase continuity condition;
determining, based at least in part on the received message, a set of consecutive downlink messages transmitted from the network entity, wherein each downlink message of the determined set of consecutive downlink messages occurs over a respective time interval and satisfies the phase continuity condition; and
estimating a property of a channel for wireless communications between the UE and the network entity using the determined set of consecutive downlink messages.

2. The method of claim 1, wherein receiving the message indicating that the network entity transitioned from the first power mode to the second power mode comprises:
receiving, from the network entity, a control message indicating that downlink messages transmitted from the network entity subsequent to the control message fail to satisfy the phase continuity condition, wherein the determined set of consecutive downlink messages excludes the downlink messages transmitted from the network entity subsequent to the control message.

3. The method of claim 2, further comprising:
determining, based at least in part on the received control message, a second set of consecutive downlink messages transmitted from the network entity, wherein the determined second set of consecutive downlink messages includes the downlink messages transmitted from the network entity subsequent to the control message, and wherein each downlink message of the determined second set of consecutive downlink messages occurs over a respective time interval and satisfies a second phase continuity condition; and
estimating the property of the channel for the wireless communications between the UE and the network entity using the determined second set of consecutive downlink messages.

4. The method of claim 1, wherein receiving the message indicating that the network entity transitioned from the first power mode to the second power mode comprises:
receiving, from the network entity, a control message indicating consecutive time intervals over which downlink messages are transmitted by the network entity while the network entity is operating in the first power mode, and wherein the determined set of consecutive downlink messages includes the downlink messages transmitted from the network entity over the indicated consecutive time intervals.

5. The method of claim 1, wherein receiving the message indicating that the network entity transitioned from the first power mode to the second power mode comprises:
receiving, from the network entity, a control message indicating a time interval over which a downlink message is transmitted from the network entity while the network entity is operating in the second power mode, and wherein the determined set of consecutive downlink messages excludes the downlink message transmitted from the network entity over the indicated time interval.

6. The method of claim 1, wherein receiving the message indicating that the network entity transitioned from the first power mode to the second power mode comprises:
receiving, from the network entity, a control message indicating a change in a transmission parameter of the network entity; and
determining, based at least in part on the indicated change in the transmission parameter of the network entity, that the network entity transitioned from the first power mode to the second power mode.

7. The method of claim 6, wherein the transmission parameter of the network entity comprises a frequency resource allocation used by the network entity for transmitting downlink messages, a transmit power used by the network entity for transmitting downlink messages, a spatial transmission relation used by the network entity for transmitting downlink messages, a number of antenna ports used by the network entity for transmitting downlink messages, or a precoder used by the network entity for transmitting downlink messages.

8. The method of claim 1, further comprising:
receiving, from the network entity, a control message indicating a first set of power modes of the network entity in which downlink messages transmitted from the network entity satisfy the phase continuity condition and a second set of power modes of the network entity in which downlink messages transmitted from the network entity fail to satisfy the phase continuity condition.

9. The method of claim 8, wherein the first set of power modes includes the first power mode and the second set of power modes includes the second power mode.

10. The method of claim 8, wherein the first set of power modes includes the first power mode and the second power mode, the method further comprising:
receiving a second control message indicating that downlink messages transmitted by the network entity subsequent to the second control message fail to satisfy the phase continuity condition, wherein the determined set of consecutive downlink messages excludes the downlink messages transmitted by the network entity subsequent to the second control message.

11. The method of claim 10, wherein the received second control message is transmitted by the network entity via layer one signaling, layer two signaling, or layer three signaling.

12. The method of claim 1, wherein the determined set of consecutive downlink messages comprises a plurality of reference signals, and wherein estimating the property of the channel comprises:
performing one or more measurements on the plurality of reference signals.

13. The method of claim 12, wherein the plurality of reference signals comprises positioning reference signals or demodulation reference signals.

14. The method of claim 1, wherein the message comprises a downlink control information message.

15. A method for wireless communication at a network entity, comprising:
transitioning from a first power mode to a second power mode based at least in part on traffic conditions associated with the wireless communication at the network entity satisfying a threshold, wherein the first power mode is associated with a phase continuity condition; and
outputting a message indicating that the network entity transitioned from the first power mode to the second power mode.

16. The method of claim 15, wherein outputting the message indicating that the network entity transitioned from the first power mode to the second power mode comprises:
outputting a control message indicating that downlink messages output from the network entity subsequent to the control message fail to satisfy the phase continuity condition.

17. The method of claim 15, wherein outputting the message indicating that the network entity transitioned from the first power mode to the second power mode comprises:
outputting a control message indicating consecutive time intervals over which downlink messages are output by the network entity while the network entity is operating in the first power mode.

18. The method of claim 15, wherein outputting the message indicating that the network entity transitioned from the first power mode to the second power mode comprises:
outputting a control message indicating a time interval over which a downlink message is output from the network entity while the network entity is operating in the second power mode.

19. The method of claim 15, wherein outputting the message indicating that the network entity transitioned from the first power mode to the second power mode comprises:
outputting a control message indicating a change in an output parameter of the network entity.

20. The method of claim 19, wherein the output parameter of the network entity comprises a frequency resource allocation used by the network entity for outputting downlink messages, a power used by the network entity for outputting downlink messages, a spatial relation used by the network entity for outputting downlink messages, a number of antenna ports used by the network entity for outputting downlink messages, or a precoder used by the network entity for outputting downlink messages.

21. The method of claim 15, further comprising:
outputting a control message indicating a first set of power modes of the network entity in which downlink messages output from the network entity satisfy the phase continuity condition and a second set of power modes of the network entity in which downlink messages output from the network entity fail to satisfy the phase continuity condition.

22. The method of claim 21, wherein the first set of power modes includes the first power mode and the second set of power modes includes the second power mode.

23. The method of claim 21, wherein the first set of power modes includes the first power mode and the second power mode, the method further comprising:
outputting a second control message indicating that downlink messages output by the network entity subsequent to the second control message fail to satisfy the phase continuity condition.

24. The method of claim 23, wherein the second control message is output by the network entity via layer one signaling, layer two signaling, or layer three signaling.

25. An apparatus for wireless communication at a user equipment (UE), comprising:
a processor;
memory coupled with the processor; and
instructions stored in the memory and executable by the processor to cause the apparatus to:
receive, from a network entity, a message indicating that the network entity transitioned from a first power mode to a second power mode, wherein the first power mode is associated with a phase continuity condition;
determine, based at least in part on the received message, a set of consecutive downlink messages transmitted from the network entity, wherein each downlink message of the determined set of consecutive downlink messages occurs over a respective time interval and satisfies the phase continuity condition; and
estimate a property of a channel for wireless communications between the UE and the network entity using the determined set of consecutive downlink messages.

26. The apparatus of claim 25, wherein the instructions to receive the message indicating that the network entity transitioned from the first power mode to the second power mode are executable by the processor to cause the apparatus to:
receive, from the network entity, a control message indicating that downlink messages transmitted from the network entity subsequent to the control message fail to satisfy the phase continuity condition, wherein the determined set of consecutive downlink messages excludes the downlink messages transmitted from the network entity subsequent to the control message.

27. The apparatus of claim 25, wherein the instructions to receive the message indicating that the network entity transitioned from the first power mode to the second power mode are executable by the processor to cause the apparatus to:
receive, from the network entity, a control message indicating a change in a transmission parameter of the network entity; and
determine, based at least in part on the indicated change in the transmission parameter of the network entity, that the network entity transitioned from the first power mode to the second power mode.

28. An apparatus for wireless communication at a network entity, comprising:
a processor;
memory coupled with the processor; and
instructions stored in the memory and executable by the processor to cause the apparatus to:
transition from a first power mode to a second power mode based at least in part on traffic conditions associated with the wireless communication at the network entity satisfying a threshold, wherein the first power mode is associated with a phase continuity condition; and
output a message indicating that the network entity transitioned from the first power mode to the second power mode.

29. The apparatus of claim 28, wherein the instructions to output the message indicating that the network entity transitioned from the first power mode to the second power mode are executable by the processor to cause the apparatus to:
output a control message indicating that downlink messages output from the network entity subsequent to the control message fail to satisfy the phase continuity condition.

30. The apparatus of claim 28, wherein the instructions to output the message indicating that the network entity transitioned from the first power mode to the second power mode are executable by the processor to cause the apparatus to:
output a control message indicating a time interval over which a downlink message is output from the network entity while the network entity is operating in the second power mode.
